(19) United States
(12) Patent Application Publication
(10) Pub. No.: US 2019/0354220 A1
(43) Pub. Date: Nov. 21, 2019

(54) TRANSPARENT DISPLAY CONTROL DEVICE

(71) Applicant: Johnson Controls Technology Company, Auburn Hills, MI (US)

(72) Inventors: Michael L. Ribbich, Oconomowoc, WI (US); Joseph R. Ribbich, Waukesha, WI (US)

(73) Assignee: Johnson Controls Technology Company, Auburn Hills, MI (US)

(21) Appl. No.: 16/413,185

(22) Filed: May 15, 2019

Related U.S. Application Data
(60) Provisional application No. 62/672,155, filed on May 16, 2018.

(51) Int. Cl. G06F 3/041; H04B 5/00; G05B 15/02; H04R 1/08; G10L 15/22

(52) U.S. Cl. CPC G06F 3/0412; H04B 5/0025; G10L 15/22; H04R 1/08; G05B 15/02

(57) ABSTRACT

A control device for a building management system (BMS) including a touch screen display configured to mount to a mounting surface, a communications interface configured to communicate with the BMS, a near field communication (NFC) sensor configured to receive information from a NFC device, a microphone configured to detect vocal input, and a processing circuit coupled to the touch screen display. The processing circuit including a processor and memory coupled to the processor, the memory storing instructions thereon that, when executed by the processor, cause the control device to receive user input from at least one of the touch screen display, the NFC sensor, or the microphone, validate an identity of a user based on the user input, and cause the BMS to control an environmental variable of a space based on the validation.

### CROSS-REFERENCE TO RELATED PATENT APPLICATION

This application claims the benefit of and priority to U.S. Provisional Patent Application No. 62/672,155 filed on May 16, 2018, entitled “Transparent Display Control Device,” the entire contents of which are incorporated by reference herein.

### BACKGROUND

The present disclosure relates generally to systems and methods for user access, and more particularly to a control device having a transparent display.

Control devices are used, in general, within building security systems (e.g., to restrict or allow access to areas of a building). Conventional control devices require users to interact with the device prior to being granted access. Various methods of interaction include keypads, the proximity of an ID badge to an RFID scanner, swiping a card through a card reader, etc.

Building security systems can be included within a building management system (BMS). A BMS can communicate with a plurality of systems, such as HVAC, security, lighting, building automation, etc. Each system in communication with a BMS can include various control devices. For example, a single room may include a panel of light switches, a thermostat, a fire alarm, and a keypad for unlocking a door. Depending on the specific circumstance, buildings may include a large number of control devices. In high security areas, for example, badge scanners, keypads, and video recorders may all be installed in relatively small spaces. In some situations, the plurality of control devices within a building or room can detract from desired aesthetics. Additionally, user and/or guests may feel uncomfortable at the sight of many control devices, which can give the appearance of heightened security.

### SUMMARY

One implementation of the present disclosure is a control device for a building management system (BMS) including a touch screen display configured to mount to a mounting surface, a communications interface configured to communicate with the BMS, a near field communication (NFC) sensor configured to receive information from a NFC device, a microphone configured to detect vocal input, and a processing circuit coupled to the touch screen display. The processing circuit including a processor and memory coupled to the processor, the memory storing instructions thereon that, when executed by the processor, cause the control device to receive user input from at least one of the touch screen display, the NFC sensor, or the microphone, validate an identity of a user based on the user input, and cause the BMS to control an environmental variable of a space based on the validation.

In some embodiments, the NFC device is a mobile device or a user identification badge. In some embodiments, controlling an environmental variable includes controlling at least one of a door lock, a window lock, a gate arm, turnstile rotation, or a garage door. In some embodiments, the control device further includes a retina sensor and wherein the instructions cause the control device to validate the user based on user input received from the retina sensor. In some embodiments, the touch screen display is a transparent touch screen display. In some embodiments, the user input from the touch screen display is a personal identification number (PIN). In some embodiments, causing the BMS to control an environmental variable includes controlling at least one of an HVAC system, a lighting system, or a security system.

Another implementation of the present disclosure is a building security system including one or more security devices configured to secure a space, a management system coupled to the one or more security devices and configured to control the one or more security devices, a user control device configured to be mounted to a surface. The user control device including a touch screen display configured to provide a user interface to a user and receive tactile input from the user, a near field communication (NFC) sensor configured to receive information from a NFC device, a microphone configured to detect vocal input, and a processing circuit configured to verify the user and, in response to verifying the user, cause the management system to control the one or more security elements.

In some embodiments, the NFC device is a mobile device or a user identification badge. In some embodiments, the one or more security devices include at least one of a door lock, a window lock, a gate arm, a turnstile, or a garage door. In some embodiments, the user control device further includes a retina sensor and wherein the user control device verifies the user based on input received from the retina sensor. In some embodiments, the touch screen display is a transparent touch screen display. In some embodiments, the tactile input from the user is a selection of a personal identification number (PIN). In some embodiments, the management system is coupled to at least one of an HVAC system, a lighting system, or a security system, and wherein the user control device is further configured to cause the management system control at least one of the HVAC system, the lighting system, or the security system.

Another implementation of the present disclosure is a method of authenticating a user for a security system including receiving, from a touch screen display, user touch input indicating a numerical sequence, receiving, from a near field communication (NFC) sensor, a user device input indicating a user identifier, receiving, from a microphone, user voice input identifying the user, validating an identity of the user based on the user touch input, the user device input, and the user voice input, and controlling one or more access devices to grant the user access to a secured space in response to validating the user.

In some embodiments, the NFC device is a mobile device or a user identification badge. In some embodiments, controlling one or more access devices to grant the user access to a secured space includes at least one of unlocking a lock, raising a gate arm, unlocking a turnstile, or opening a garage door. In some embodiments, the method further includes receiving, from a biometric sensor, a user biometric input, wherein the user biometric input is a retina scan. In some embodiments, the biometric input is a fingerprint scan. In some embodiments, the touch screen display is a transparent touch screen display.

### BRIEF DESCRIPTION OF THE DRAWINGS

FIG. 1 is a drawing of a building equipped with a HVAC system, according to some embodiments.

FIG. 2 is a drawing of the building of FIG. 1, shown in greater detail, according to some embodiments.

FIG. 3 is a block diagram of a waterside system which can be used to serve the building of FIG. 1, according to some embodiments.

FIG. 4 is a block diagram of an airside system which can be used to serve the building of FIG. 1, according to some embodiments.

FIG. 5 is block diagram of a building management system (BMS) which may be used to monitor and control the building of FIG. 1, according to some embodiments.

FIG. 6 is a block diagram illustrating a control device, according to some embodiments.

FIG. 7 is a view of a control device shown in both a horizontal and vertical orientation, according to some embodiments.

FIG. 8 is a view of another control device shown in both a horizontal and vertical orientation, according to some embodiments.

FIG. 9A is a perspective view schematic drawing of an installation assembly for the control devices shown in FIGS. 6-8, according to some embodiments.

FIG. 9B is an exploded view schematic drawing of the installation assembly shown in FIG. 9A, according to some embodiments.

FIG. 9C is a planar, top view schematic drawing of the installation assembly illustrated in FIG. 9A, according to some embodiments.

FIG. 9D is a planar, front view schematic drawing of the installation assembly illustrated in FIG. 9A, according to some embodiments.

FIG. 9E is a planar, bottom view schematic drawing of the installation assembly illustrated in FIG. 9A, according to some embodiments.

FIG. 9F is a planar, side view schematic drawing of the installation assembly illustrated in FIG. 9A, according to some embodiments.

FIG. 9G is a planar, back view schematic drawing of the installation assembly illustrated in FIG. 9A, according to some embodiments.

FIG. 9H is a perspective view schematic drawing of an installation assembly for the control device shown in FIGS. 8A-8B, according to some embodiments.

FIG. 9I is an exploded view schematic drawing of the installation assembly shown in FIG. 9H, according to some embodiments.

FIG. 9J is a planar, top view schematic drawing of the installation assembly illustrated in FIG. 9H according to some embodiments.

FIG. 9K is a planar, front view schematic drawing of the installation assembly illustrated in FIG. 9H according to some embodiments.

FIG. 9L is a planar, bottom view schematic drawing of the installation assembly illustrated in FIG. 9H according to some embodiments.

FIG. 9M is a planar, side view schematic drawing of the installation assembly illustrated in FIG. 9H according to some embodiments.

FIG. 9N is a planar, back view schematic drawing of the installation assembly illustrated in FIG. 9H according to some embodiments.

FIG. 10A is a planar, side view schematic drawing illustrating one or more physical features of a control device, according to some embodiments.

FIG. 10B is a planar, front view schematic drawing illustrating one or more physical features of the control device illustrated in FIG. 10A, according to some embodiments.

FIG. 10C is a perspective view schematic drawing illustrating one or more physical features of the control device illustrated in FIG. 10A, according to some embodiments.

FIG. 11A is a planar, side view schematic drawing illustrating one or more physical features of a control device, according to some embodiments.

FIG. 11B is a planar, front view schematic drawing illustrating one or more physical features of the control device illustrated in FIG. 11A in an upright configuration, according to some embodiments.

FIG. 11C is a planar, front view schematic drawing illustrating one or more physical features of the control device illustrated in FIG. 11A in an sideways configuration, according to some embodiments.

FIG. 11D is a perspective view schematic drawing illustrating one or more physical features of the control device illustrated in FIG. 11A, according to some embodiments.

FIG. 12A is a planar, side view schematic drawing illustrating one or more physical features of a control device, according to some embodiments.

FIG. 12B is a planar, front view schematic drawing illustrating one or more physical features of the control device illustrated in FIG. 12A, according to some embodiments.

FIG. 12C is a perspective view schematic drawing illustrating one or more physical features of the control device illustrated in FIG. 12A, according to some embodiments.

FIG. 13A is a planar, side view schematic drawing illustrating one or more physical features of a control device, according to some embodiments.

FIG. 13B is a planar, front view schematic drawing illustrating one or more physical features of the control device illustrated in FIG. 13A, according to some embodiments.

FIG. 13C is a perspective view schematic drawing illustrating one or more physical features of the control device illustrated in FIG. 13A, according to some embodiments.

FIG. 14A is a planar, side view schematic drawing illustrating one or more physical features of a control device, according to some embodiments.

FIG. 14B is a planar, front view schematic drawing illustrating one or more physical features of the control device illustrated in FIG. 14A, according to some embodiments.

FIG. 14C is a perspective view schematic drawing illustrating one or more physical features of the control device illustrated in FIG. 14A, according to some embodiments.

FIG. 15A is a planar, side view schematic drawing illustrating one or more physical features of a control device, according to some embodiments.

FIG. 15B is a planar, front view schematic drawing illustrating one or more physical features of the control device illustrated in FIG. 15A, according to some embodiments.

FIG. 15C is a perspective view schematic drawing illustrating one or more physical features of the control device illustrated in FIG. 15A, according to some embodiments.

FIG. 16A is a planar, side view schematic drawing illustrating one or more physical features of a control device, according to some embodiments.

FIG. 16B is a planar, front view schematic drawing illustrating one or more physical features of the control device illustrated in FIG. 10A, according to some embodiments.

FIG. 16C is a perspective view schematic drawing illustrating one or more physical features of the control device illustrated in FIG. 10A, according to some embodiments.

FIG. 17A is a planar, side view schematic drawing illustrating one or more physical features of a control device, according to some embodiments.

FIG. 17B is a planar, front view schematic drawing illustrating one or more physical features of the control device illustrated in FIG. 17A, according to some embodiments.

FIG. 17C is a perspective view schematic drawing illustrating one or more physical features of the control device illustrated in FIG. 17A, according to some embodiments.

FIG. 18A is a planar, side view schematic drawing illustrating one or more physical features of a control device, according to some embodiments.

FIG. 18B is a planar, front view schematic drawing illustrating one or more physical features of the control device illustrated in FIG. 18A, according to some embodiments.

FIG. 18C is a perspective view schematic drawing illustrating one or more physical features of the control device illustrated in FIG. 18A, according to some embodiments.

FIG. 19A is a planar, side view schematic drawing illustrating one or more physical features of a control device, according to some embodiments.

FIG. 19B is a planar, front view schematic drawing illustrating one or more physical features of the control device illustrated in FIG. 19A, according to some embodiments.

FIG. 19C is a perspective view schematic drawing illustrating one or more physical features of the control device illustrated in FIG. 19A, according to some embodiments.

FIG. 20A is a planar, side view schematic drawing illustrating one or more physical features of a control device, according to some embodiments.

FIG. 20B is a planar, front view schematic drawing illustrating one or more physical features of the control device illustrated in FIG. 20A, according to some embodiments.

FIG. 20C is a perspective view schematic drawing illustrating one or more physical features of the control device illustrated in FIG. 20A, according to some embodiments.

FIG. 21A is a planar, side view schematic drawing illustrating one or more physical features of a control device, according to some embodiments.

FIG. 21B is a planar, front view schematic drawing illustrating one or more physical features of the control device illustrated in FIG. 21A, according to some embodiments.

FIG. 21C is a perspective view schematic drawing illustrating one or more physical features of the control device illustrated in FIG. 21A, according to some embodiments.

FIG. 22A is a planar, side view schematic drawing illustrating one or more physical features of a control device, according to some embodiments.

FIG. 22B is a planar, front view schematic drawing illustrating one or more physical features of the control device illustrated in FIG. 22A, according to some embodiments.

FIG. 22C is a planar, top view schematic drawing illustrating one or more physical features of the control device illustrated in FIG. 22A, according to some embodiments.

FIG. 22D is a perspective view schematic drawing illustrating one or more physical features of the control device illustrated in FIG. 22A, according to some embodiments.

FIG. 23A is a planar, side view schematic drawing illustrating one or more physical features of a control device, according to some embodiments.

FIG. 23B is a planar, front view schematic drawing illustrating one or more physical features of the control device illustrated in FIG. 23A, according to some embodiments.

FIG. 23C is a perspective view schematic drawing illustrating one or more physical features of the control device illustrated in FIG. 23A, according to some embodiments.

FIG. 24A is a planar, side view schematic drawing illustrating one or more physical features of a control device, according to some embodiments.

FIG. 24B is a planar, front view schematic drawing illustrating one or more physical features of the control device illustrated in FIG. 24A, according to some embodiments.

FIG. 24C is a planar, top view schematic drawing illustrating one or more physical features of the control device illustrated in FIG. 24A, according to some embodiments.

FIG. 24D is a perspective view schematic drawing illustrating one or more physical features of the control device illustrated in FIG. 24A, according to some embodiments.

FIG. 25A is a planar, side view schematic drawing illustrating one or more physical features of a control device, according to some embodiments.

FIG. 25B is a planar, front view schematic drawing illustrating one or more physical features of the control device illustrated in FIG. 25A, according to some embodiments.

FIG. 25C is a perspective view schematic drawing illustrating one or more physical features of the control device illustrated in FIG. 25A, according to some embodiments.

FIG. 26A is a planar, side view schematic drawing illustrating one or more physical features of a control device, according to some embodiments.

FIG. 26B is a planar, front view schematic drawing illustrating one or more physical features of the control device illustrated in FIG. 26A, according to some embodiments.

FIG. 26C is a perspective view schematic drawing illustrating one or more physical features of the control device illustrated in FIG. 26A, according to some embodiments.

FIG. 27A is a planar, side view schematic drawing illustrating one or more physical features of a control device, according to some embodiments.

FIG. 27B is a planar, front view schematic drawing illustrating one or more physical features of the control device illustrated in FIG. 27A, according to some embodiments.

FIG. 27C is a perspective view schematic drawing illustrating one or more physical features of the control device illustrated in FIG. 27A, according to some embodiments.

FIG. 27D is a perspective view schematic drawing illustrating one or more physical features of the control device illustrated in FIG. 27A, according to some embodiments.

FIG. 28A is a perspective view schematic drawing illustrating one or more physical features of a control device, according to some embodiments.

FIG. 28B is a perspective view schematic drawing illustrating one or more physical features of a control device, according to some embodiments.

FIG. 28C is a perspective view schematic drawing illustrating one or more physical features of a control device, according to some embodiments.

FIG. 29 is a drawing of the connections of the control devices of FIGS. 6-28C, according to some embodiments.

FIG. 30 is a floorplan of a home with a main control device in one room and several external control devices, according to some embodiments.

FIG. 31 is a diagram of a communications system located in the building of FIGS. 1 and 2, according to an exemplary embodiment.

FIGS. 32A-32B are flow diagrams illustrating operations for monitoring and controlling connected equipment via a local interface of a control device, according to some embodiments.

FIGS. 33A-33B are flow diagrams illustrating operations for receiving status information from building subsystems and sending an alert to a user device if the status information does not match a predetermined system status, according to some embodiments.

FIG. 34A is a diagram of operations in which the control device communicates with a user device via NFC, according to some embodiments.

FIG. 34B is a flow diagram of the operations described in FIG. 34A, according to some embodiments.

FIG. 35 is a diagram of operations in which a control device is locked and unlocked via NFC, according to some embodiments.

FIG. 36 is a diagram of operations for authenticating a user to access a network through a control device, according to some embodiments.

FIG. 37 is a general block diagram illustrating the payment module of the control device in greater detail, according to some embodiments.

FIG. 38 is schematic drawing of a payment module including a card reading device for a control device, according to some embodiments.

FIG. 39 is a schematic drawing of a control device including a card reading device for receiving information from a card, according to some embodiments.

FIG. 40 is a schematic drawing of a control device including an input device for remotely receiving information from a card or other device, according to some embodiments.

FIG. 41 is a flow diagram of operations for making a payment with a control device, according to some embodiments.

FIG. 42 is a flow diagram of operations for controlling user access via a control device, according to some embodiments.

FIG. 43 is another flow diagram of operations for controlling user access via a control device, according to some embodiments.

FIG. 44 is a flow diagram of operations for controlling and monitoring user access via a control device, according to some embodiments.

FIG. 45 is a flow diagram of operations for personalizing settings and controlling user access via a control device, according to some embodiments.

FIG. 46 is a flow diagram of operations for controlling user access via a control device with varying security levels, according to some embodiments.

FIG. 47 is a flow diagram of operations for controlling user access via a control device with payment options, according to some embodiments.

### DETAILED DESCRIPTION

### Overview

The present disclosure generally relates to user access, and more specifically relates to a control device configured to monitor and regulate access. Referring generally to the FIGURES, systems and methods for controlling user access are shown, according to various exemplary embodiments.

The present disclosure describes a control device that includes a plurality of features directed towards monitoring and controlling building subsystems (including, for example, security). In some embodiments, the control device may be configured to control door locks (e.g., smart locks), window locks, gate arms (e.g., in parking garages), turnstile rotation, garage doors, and other access devices/systems. The control device may be in communication with a building management system, which may be configured to signal security breaches (e.g., via building alarms, user notifications, etc.).

In some embodiments, the control device may include a transparent display, where the matter behind the display is visible in the non-active display portions. The transparent display may be configured to accept touch inputs (e.g., via a touchscreen). In some embodiments, the transparent display may have the dimensions 4 inches×3 inches. However, the transparent display may be a different size depending on the desired implementation.

In some embodiments, the control device may be used outside and/or within homes, office buildings, laboratories, hotels, parking garages, and any other setting where access control is desired. Accordingly, the control device may utilize different functions depending upon the specific setting. For example, a homeowner may prefer a single user verification method (such as entering a PIN via the control device), whereas an office building owner may prefer several layers of user verification (e.g., scanning a badge, voice recognition, facial recognition, etc.).

In some embodiments, the control device may include features that extend beyond access control. In some non-limiting embodiments, for example, the control device may access a network that provides weather information to the control device. Accordingly, in a situation of severe weather, the control device may be able to alert users. In some non-limiting embodiments, for example, the control device may identify users and determine their preferred settings (e.g., room temperature, lighting, etc.). Further, in some embodiments, the control device may function as a payment device. For example, a user may interact with the control device to process a payment prior to gaining access to a parking garage. Further embodiments and features of the control device are described in detail herein.

### Building HVAC Systems and Building Management Systems

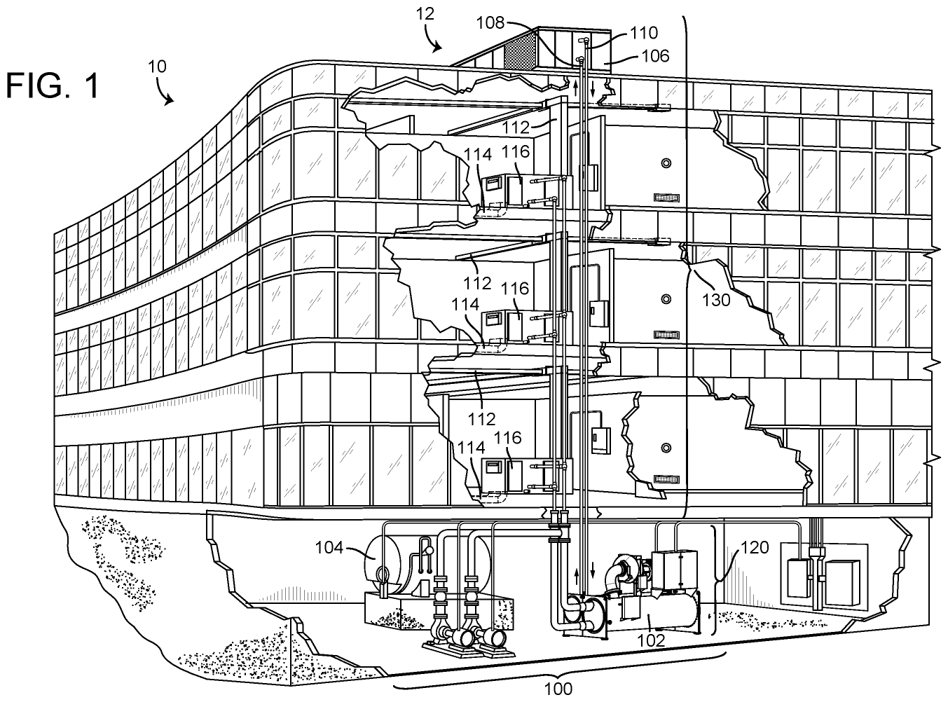

Referring now to FIGS. 1-5, an exemplary building management system (BMS) and HVAC system in which the systems and methods of the present disclosure may be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

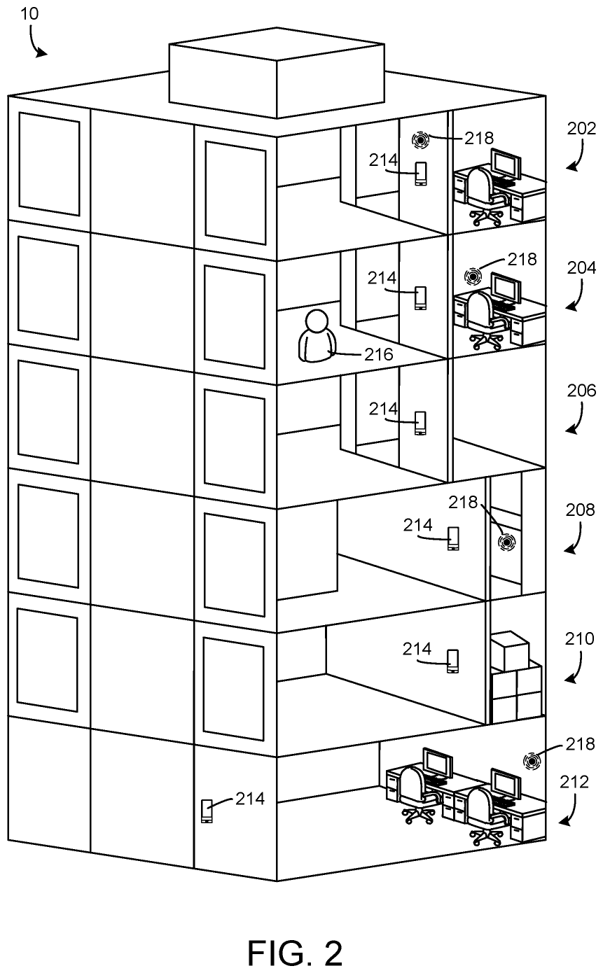

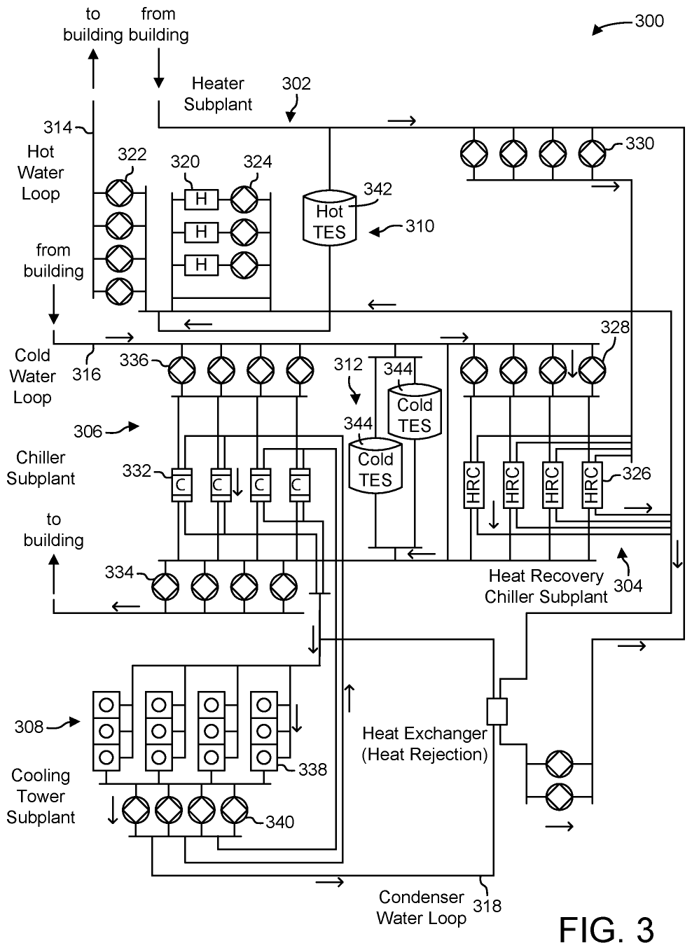

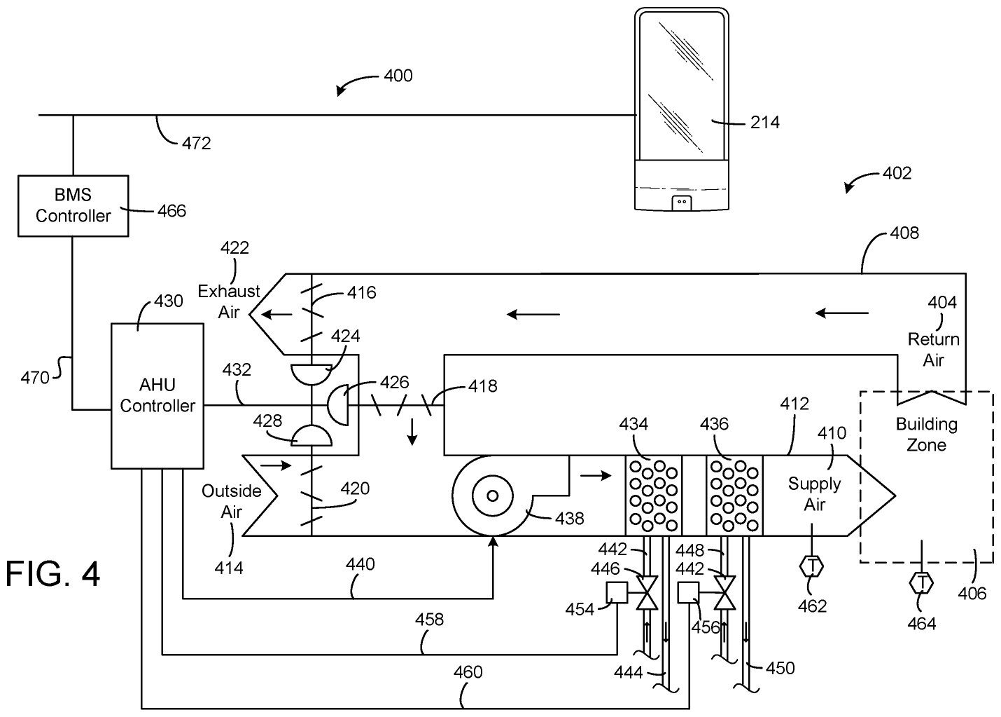

The BMS that serves building 10 includes an HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which may be used in HVAC system 100 are described in greater detail with reference to FIGS. 3-4.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that can be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

Referring now to FIG. 2, building 10 is shown in greater detail, according to an exemplary embodiment. Building 10 may have multiple zones. In FIG. 2, building 10 has zones, 202, 204, 206, 208, 210, and 212. In building 10, the zones each correspond to a separate floor. In various embodiments, the zones of building 10 may be rooms, sections of a floor, multiple floors, etc. Each zone may have a corresponding control device 214. In some embodiments, control device 214 is at least one of a sensor, a controller, a display device, etc. Control device 214 may take input from users. The input may be a verbal password, typed password, biometric, access card, etc. In some embodiments, control device 214 can grant or deny access to one or more of zones 202-212, cause building announcements to be played in one or more of zones 202-212, cause the temperature and/or humidity and/or lighting to be regulated in one or more of zones 202-212, and/or any other control action.

In some embodiments, building 10 has wireless transmitters 218 in each or some of zones 202-212. The wireless transmitters 218 may be routers, coordinators, and/or any other device broadcasting radio waves. In some embodiments, wireless transmitters 218 form a Wi-Fi network, a Zigbee network, a Bluetooth network, and/or any other kind of network.

In some embodiments, user 216 has a mobile device that can communicate with wireless transmitters 218. Control device 214 may use the signal strengths between the mobile device of occupant 216 and the wireless transmitters 218 to determine what zone the occupant is in.

In some embodiments, control devices 214 are connected to a building management system, a weather server, and/or a building emergency sensor(s). In some embodiments, control devices 214 may receive emergency notifications from the building management system, the weather server, and/or the building emergency sensor(s). Based on the nature of the emergency, control devices 214 may give directions to an occupant of the building. In some embodiments, the direction may be to respond to an emergency (e.g., call the police, hide and turn the lights off, etc.) In various embodiments, the directions given to the occupant (e.g., occupant 216) may be navigation directions. For example, zone 212 may be a safe zone with no windows for an individual (e.g., user 216). If control devices 214 determine that there are high winds around building 10, the control device 214 may direct occupants of zones 202-210 to zone 212 if zone 212 has no windows.

Referring now to FIG. 3, a block diagram of a waterside system 300 is shown, according to an exemplary embodiment. In various embodiments, waterside system 300 may supplement or replace waterside system 120 in HVAC system 100 or may be implemented separate from HVAC system 100. When implemented in HVAC system 100, waterside system 300 may include a subset of the HVAC devices in HVAC system 100 (e.g., boiler 104, chiller 102, pumps, valves, etc.) and may operate to supply a heated or chilled fluid to AHU 106. The HVAC devices of waterside system 300 may be located within building 10 (e.g., as components of waterside system 120) or at an offsite location such as a central plant.

In FIG. 3, waterside system 300 is shown as a central plant having a plurality of subplants 302-312. Subplants 302-312 are shown to include a heater subplant 302, a heat recovery chiller subplant 304, a chiller subplant 306, a cooling tower subplant 308, a hot thermal energy storage (TES) subplant 310, and a cold thermal energy storage (TES) subplant 312. Subplants 302-312 consume resources (e.g., water, natural gas, electricity, etc.) from utilities to serve the thermal energy loads (e.g., hot water, cold water, heating, cooling, etc.) of a building or campus. For example, heater subplant 302 may be configured to heat water in a hot water loop 314 that circulates the hot water between heater subplant 302 and building 10. Chiller subplant 306 may be configured to chill water in a cold water loop 316 that circulates the cold water between chiller subplant 306 building 10. Heat recovery chiller subplant 304 may be configured to transfer heat from cold water loop 316 to hot water loop 314 to provide additional heating for the hot water and additional cooling for the cold water. Condenser water loop 318 may absorb heat from the cold water in chiller subplant 306 and reject the absorbed heat in cooling tower subplant 308 or transfer the absorbed heat to hot water loop 314. Hot TES subplant 310 and cold TES subplant 312 may store hot and cold thermal energy, respectively, for subsequent use.

Hot water loop 314 and cold water loop 316 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 302-312 to receive further heating or cooling.

Although subplants 302-312 are shown and described as heating and cooling water for circulation to a building, it is understood that any other type of working fluid (e.g., glycol, CO2, etc.) may be used in place of or in addition to water to serve the thermal energy loads. In other embodiments, subplants 302-312 may provide heating and/or cooling directly to the building or campus without requiring an intermediate heat transfer fluid. These and other variations to waterside system 300 are within the teachings of the present disclosure.

Each of subplants 302-312 may include a variety of equipment configured to facilitate the functions of the subplant. For example, heater subplant 302 is shown to include a plurality of heating elements 320 (e.g., boilers, electric heaters, etc.) configured to add heat to the hot water in hot water loop 314. Heater subplant 302 is also shown to include several pumps 322 and 324 configured to circulate the hot water in hot water loop 314 and to control the flow rate of the hot water through individual heating elements 320. Chiller subplant 306 is shown to include a plurality of chillers 332 configured to remove heat from the cold water in cold water loop 316. Chiller subplant 306 is also shown to include several pumps 334 and 336 configured to circulate the cold water in cold water loop 316 and to control the flow rate of the cold water through individual chillers 332.

Heat recovery chiller subplant 304 is shown to include a plurality of heat recovery heat exchangers 326 (e.g., refrigeration circuits) configured to transfer heat from cold water loop 316 to hot water loop 314. Heat recovery chiller subplant 304 is also shown to include several pumps 328 and 330 configured to circulate the hot water and/or cold water through heat recovery heat exchangers 326 and to control the flow rate of the water through individual heat recovery heat exchangers 326. Cooling tower subplant 308 is shown to include a plurality of cooling towers 338 configured to remove heat from the condenser water in condenser water loop 318. Cooling tower subplant 308 is also shown to include several pumps 340 configured to circulate the condenser water in condenser water loop 318 and to control the flow rate of the condenser water through individual cooling towers 338.

Hot TES subplant 310 is shown to include a hot TES tank 342 configured to store the hot water for later use. Hot TES subplant 310 may also include one or more pumps or valves configured to control the flow rate of the hot water into or out of hot TES tank 342. Cold TES subplant 312 is shown to include cold TES tanks 344 configured to store the cold water for later use. Cold TES subplant 312 may also include one or more pumps or valves configured to control the flow rate of the cold water into or out of cold TES tanks 344.

In some embodiments, one or more of the pumps in waterside system 300 (e.g., pumps 322, 324, 328, 330, 334, 336, and/or 340) or pipelines in waterside system 300 include an isolation valve associated therewith. Isolation valves may be integrated with the pumps or positioned upstream or downstream of the pumps to control the fluid flows in waterside system 300. In various embodiments, waterside system 300 may include more, fewer, or different types of devices and/or subplants based on the particular configuration of waterside system 300 and the types of loads served by waterside system 300.

Referring now to FIG. 4, airside system 400 is shown to include an economizer-type air handling unit (AHU) 402. Economizer-type AHUs vary the amount of outside air and return air used by the air handling unit for heating or cooling. For example, AHU 402 may receive return air 404 from building zone 406 via return air duct 408 and may deliver supply air 410 to building zone 406 via supply air duct 412. In some embodiments, AHU 402 is a rooftop unit located on the roof of building 10 (e.g., AHU 106 as shown in FIG. 1) or otherwise positioned to receive both return air 404 and outside air 414. AHU 402 may be configured to operate exhaust air damper 416, mixing damper 418, and outside air damper 420 to control an amount of outside air 414 and return air 404 that combine to form supply air 410. Any return air 404 that does not pass through mixing damper 418 may be exhausted from AHU 402 through exhaust damper 416 as exhaust air 422.

Each of dampers 416-420 may be operated by an actuator. For example, exhaust air damper 416 may be operated by actuator 424, mixing damper 418 may be operated by actuator 426, and outside air damper 420 may be operated by actuator 428. Actuators 424-428 may communicate with an AHU controller 430 via a communications link 432. Actuators 424-428 may receive control signals from AHU controller 430 and may provide feedback signals to AHU controller 430. Feedback signals may include, for example, an indication of a current actuator or damper position, an amount of torque or force exerted by the actuator, diagnostic information (e.g., results of diagnostic tests performed by actuators 424-428), status information, commissioning information, configuration settings, calibration data, and/or other types of information or data that may be collected, stored, or used by actuators 424-428. AHU controller 430 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 424-428.

Still referring to FIG. 4, AHU 402 is shown to include a cooling coil 434, a heating coil 436, and a fan 438 positioned within supply air duct 412. Fan 438 may be configured to force supply air 410 through cooling coil 434 and/or heating coil 436 and provide supply air 410 to building zone 406. AHU controller 430 may communicate with fan 438 via communications link 440 to control a flow rate of supply air 410. In some embodiments, AHU controller 430 controls an amount of heating or cooling applied to supply air 410 by modulating a speed of fan 438.

Cooling coil 434 may receive a chilled fluid from waterside system 300 (e.g., from cold water loop 316) via piping 442 and may return the chilled fluid to waterside system 300 via piping 444. Valve 446 may be positioned along piping 442 or piping 444 to control a flow rate of the chilled fluid through cooling coil 474. In some embodiments, cooling coil 434 includes multiple stages of cooling coils that can be independently activated and deactivated (e.g., by AHU controller 430, by BMS controller 466, etc.) to modulate an amount of cooling applied to supply air 410.

Heating coil 436 may receive a heated fluid from waterside system 300 (e.g., from hot water loop 314) via piping 448 and may return the heated fluid to waterside system 300 via piping 450. Valve 452 may be positioned along piping 448 or piping 450 to control a flow rate of the heated fluid through heating coil 436. In some embodiments, heating coil 436 includes multiple stages of heating coils that can be independently activated and deactivated (e.g., by AHU controller 430, by BMS controller 466, etc.) to modulate an amount of heating applied to supply air 410.

Each of valves 446 and 452 may be controlled by an actuator. For example, valve 446 may be controlled by actuator 454 and valve 452 may be controlled by actuator 456. Actuators 454-456 may communicate with AHU controller 430 via communications links 458-460. Actuators 454-456 may receive control signals from AHU controller 430 and may provide feedback signals to controller 430. In some embodiments, AHU controller 430 receives a measurement of the supply air temperature from a temperature sensor 462 positioned in supply air duct 412 (e.g., downstream of cooling coil 434 and/or heating coil 436). AHU controller 430 may also receive a measurement of the temperature of building zone 406 from a temperature sensor 464 located in building zone 406.

In some embodiments, AHU controller 430 operates valves 446 and 452 via actuators 454-456 to modulate an amount of heating or cooling provided to supply air 410 (e.g., to achieve a set point temperature for supply air 410 or to maintain the temperature of supply air 410 within a set point temperature range). The positions of valves 446 and 452 affect the amount of heating or cooling provided to supply air 410 by cooling coil 434 or heating coil 436 and may correlate with the amount of energy consumed to achieve a desired supply air temperature. AHU 430 may control the temperature of supply air 410 and/or building zone 406 by activating or deactivating coils 434-436, adjusting a speed of fan 438, or a combination of both.

Still referring to FIG. 4, airside system 400 is shown to include a building management system controller 466 and a control device 214. BMS controller 466 may include one or more computer systems (e.g., servers, supervisory controllers, subsystem controllers, etc.) that serve as system level controllers, application or data servers, head nodes, or master controllers for airside system 400, waterside system 300, HVAC system 100, and/or other controllable systems that serve building 10. BMS controller 466 may communicate with multiple downstream building systems or subsystems (e.g., HVAC system 100, a security system, a lighting system, waterside system 300, etc.) via a communications link 470 according to like or disparate protocols (e.g., LON, BACnet, etc.). In various embodiments, AHU controller 430 and BMS controller 466 may be separate (as shown in FIG. 4) or integrated. In an integrated implementation, AHU controller 430 may be a software module configured for execution by a processor of BMS controller 466.

In some embodiments, AHU controller 430 receives information from BMS controller 466 (e.g., commands, set points, operating boundaries, etc.) and provides information to BMS controller 466 (e.g., temperature measurements, valve or actuator positions, operating statuses, diagnostics, etc.). For example, AHU controller 430 may provide BMS controller 466 with temperature measurements from temperature sensors 462-464, equipment on/off states, equipment operating capacities, and/or any other information that can be used by BMS controller 466 to monitor or control a variable state or condition within building zone 406.

Control device 214 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Control device 214 may be a computer workstation, a client terminal, a remote or local interface, or any other type of user interface device. Control device 214 may be a stationary terminal or a mobile device. For example, control device 214 may be a desktop computer, a computer server with a user interface, a laptop computer, a tablet, a smartphone, a PDA, or any other type of mobile or non-mobile device. Control device 214 may communicate with BMS controller 466 and/or AHU controller 430 via communications link 472.

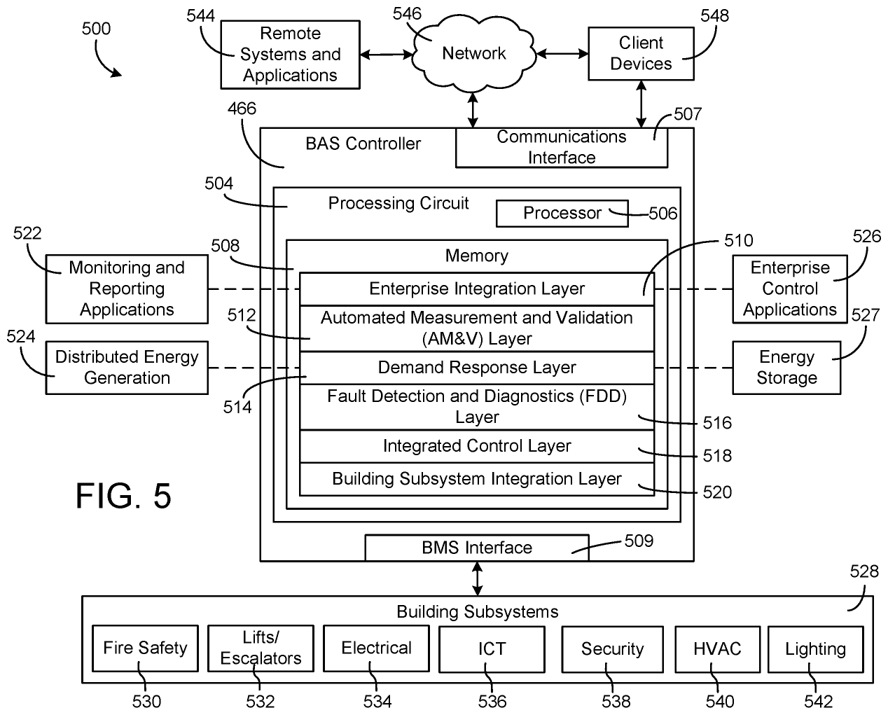

Referring now to FIG. 5, a block diagram of a building management system (BMS) 500 is shown, according to some embodiments. BMS 500 may be implemented in building 10 to automatically monitor and control various building functions. BMS 500 is shown to include BMS controller 466 and a plurality of building subsystems 528. Building subsystems 528 are shown to include a building electrical subsystem 534, an information communication technology (ICT) subsystem 536, a security subsystem 538, a HVAC subsystem 540, a lighting subsystem 542, a lift/escalators subsystem 532, and a fire safety subsystem 530. In various embodiments, building subsystems 528 may include fewer, additional, or alternative subsystems. For example, building subsystems 528 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 528 include waterside system 300 and/or airside system 400, as described with reference to FIGS. 3-4.

Each of building subsystems 528 may include any number of devices, controllers, and connections for completing its individual functions and control activities. HVAC subsystem 540 may include many of the same components as HVAC system 100, as described with reference to FIGS. 1-4. For example, HVAC subsystem 540 may include a chiller, a boiler, any number of air handling units, economizers, field controllers, supervisory controllers, actuators, temperature sensors, and other devices for controlling the temperature, humidity, airflow, or other variable conditions within building 10. Lighting subsystem 542 may include any number of light fixtures, ballasts, lighting sensors, dimmers, or other devices configured to controllably adjust the amount of light provided to a building space. Security subsystem 538 may include occupancy sensors, video surveillance cameras, digital video recorders, video processing servers, intrusion detection devices, access control devices and servers, or other security-related devices.

Still referring to FIG. 5, BMS controller 466 is shown to include a communications interface 507 and a BMS interface 509. Interface 507 may facilitate communications between BMS controller 466 and external applications (e.g., monitoring and reporting applications 522, enterprise control applications 526, remote systems and applications 544, applications residing on client devices 548, etc.) for allowing user control, monitoring, and adjustment to BMS controller 466 and/or subsystems 528. Interface 507 may also facilitate communications between BMS controller 466 and client devices 548. BMS interface 509 may facilitate communications between BMS controller 466 and building subsystems 528 (e.g., HVAC, lighting security, lifts, power distribution, business, etc.).

Interfaces 507, 509 may be or include wired or wireless communications interfaces (e.g., jacks, antennas, transmitters, receivers, transceivers, wire terminals, etc.) for conducting data communications with building subsystems 528 or other external systems or devices. In various embodiments, communications via interfaces 507, 509 may be direct (e.g., local wired or wireless communications) or via a communications network 546 (e.g., a WAN, the Internet, a cellular network, etc.). For example, interfaces 507, 509 may include an Ethernet card and port for sending and receiving data via an Ethernet-based communications link or network. In another example, interfaces 507, 509 may include a Wi-Fi transceiver for communicating via a wireless communications network. In another example, one or both of interfaces 507, 509 may include cellular or mobile phone communications transceivers. In one embodiment, communications interface 507 is a power line communications interface and BMS interface 509 is an Ethernet interface. In other embodiments, both communications interface 507 and BMS interface 509 are Ethernet interfaces or are the same Ethernet interface.

Still referring to FIG. 5, BMS controller 466 is shown to include a processing circuit 504 including a processor 506 and memory 508. Processing circuit 504 may be communicably connected to BMS interface 509 and/or communications interface 507 such that processing circuit 504 and the various components thereof may send and receive data via interfaces 507, 509. Processor 506 may be implemented as a general purpose processor, an application specific integrated circuit (ASIC), one or more field programmable gate arrays (FPGAs), a group of processing components, or other suitable electronic processing components.

Memory 508 (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present application. Memory 508 may be or include volatile memory or non-volatile memory. Memory 508 may include database components, object code components, script components, or any other type of information structure for supporting the various activities and information structures described in the present application. According to some embodiments, memory 508 is communicably connected to processor 506 via processing circuit 504 and includes computer code for executing (e.g., by processing circuit 504 and/or processor 506) one or more processes described herein.

In some embodiments, BMS controller 466 is implemented within a single computer (e.g., one server, one housing, etc.). In various other embodiments BMS controller 466 may be distributed across multiple servers or computers (e.g., that may exist in distributed locations). Further, while FIG. 5 shows applications 522 and 526 as existing outside of BMS controller 466, in some embodiments, applications 522 and 526 may be hosted within BMS controller 466 (e.g., within memory 508).

Still referring to FIG. 5, memory 508 is shown to include an enterprise integration layer 510, an automated measurement and validation (AM&V) layer 512, a demand response (DR) layer 514, a fault detection and diagnostics (FDD) layer 516, an integrated control layer 518, and a building subsystem integration later 520. Layers 510-520 may be configured to receive inputs from building subsystems 528 and other data sources, determine optimal control actions for building subsystems 528 based on the inputs, generate control signals based on the optimal control actions, and provide the generated control signals to building subsystems 528. The following paragraphs describe some of the general functions performed by each of layers 510-520 in BMS 500.

Enterprise integration layer 510 may be configured to serve clients or local applications with information and services to support a variety of enterprise-level applications. For example, enterprise control applications 526 may be configured to provide subsystem-spanning control to a graphical user interface (GUI) or to any number of enterprise-level business applications (e.g., accounting systems, user identification systems, etc.). Enterprise control applications 526 may also or alternatively be configured to provide configuration GUIs for configuring BMS controller 466. In yet other embodiments, enterprise control applications 526 may work with layers 510-520 to optimize building performance (e.g., efficiency, energy use, comfort, or safety) based on inputs received at interface 507 and/or BMS interface 509.

Building subsystem integration layer 520 may be configured to manage communications between BMS controller 466 and building subsystems 528. For example, building subsystem integration layer 520 may receive sensor data and input signals from building subsystems 528 and provide output data and control signals to building subsystems 528. Building subsystem integration layer 520 may also be configured to manage communications between building subsystems 528. Building subsystem integration layer 520 translate communications (e.g., sensor data, input signals, output signals, etc.) across a plurality of multi-vendor/multi-protocol systems.

Demand response layer 514 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 524, from energy storage 527 (e.g., hot TES 342, cold TES 344, etc.), or from other sources. Demand response layer 514 may receive inputs from other layers of BMS controller 466 (e.g., building subsystem integration layer 520, integrated control layer 518, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 514 includes control logic for responding to the data and signals it receives. These responses may include communicating with the control algorithms in integrated control layer 518, changing control strategies, changing setpoints, or activating/deactivating building equipment or subsystems in a controlled manner. Demand response layer 514 may also include control logic configured to determine when to utilize stored energy. For example, demand response layer 514 may determine to begin using energy from energy storage 527 just prior to the beginning of a peak use hour.

In some embodiments, demand response layer 514 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 514 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 514 may further include or draw upon one or more demand response policy definitions (e.g., databases, XML files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions may specify which equipment may be turned on or off in response to particular demand inputs, how long a system or piece of equipment should be turned off, what setpoints may be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 518 may be configured to use the data input or output of building subsystem integration layer 520 and/or demand response later 514 to make control decisions. Due to the subsystem integration provided by building subsystem integration layer 520, integrated control layer 518 may integrate control activities of the subsystems 528 such that the subsystems 528 behave as a single integrated supersystem. In some embodiments, integrated control layer 518 includes control logic that uses inputs and outputs from a plurality of building subsystems to provide greater comfort and energy savings relative to the comfort and energy savings that separate subsystems could provide alone. For example, integrated control layer 518 may be configured to use an input from a first subsystem to make an energy-saving control decision for a second subsystem. Results of these decisions may be communicated back to building subsystem integration layer 520.

Integrated control layer 518 is shown to be logically below demand response layer 514. Integrated control layer 518 may be configured to enhance the effectiveness of demand response layer 514 by enabling building subsystems 528 and their respective control loops to be controlled in coordination with demand response layer 514. This configuration may advantageously reduce disruptive demand response behavior relative to conventional systems. For example, integrated control layer 518 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 518 may be configured to provide feedback to demand response layer 514 so that demand response layer 514 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 518 is also logically below fault detection and diagnostics layer 516 and automated measurement and validation layer 512. Integrated control layer 518 may be configured to provide calculated inputs (e.g., aggregations) to these higher levels based on outputs from more than one building subsystem.

Automated measurement and validation (AM&V) layer 512 may be configured to verify that control strategies commanded by integrated control layer 518 or demand response layer 514 are working properly (e.g., using data aggregated by AM&V layer 512, integrated control layer 518, building subsystem integration layer 520, FDD layer 516, or otherwise). The calculations made by AM&V layer 512 may be based on building system energy models and/or equipment models for individual BMS devices or subsystems. For example, AM&V layer 512 may compare a model-predicted output with an actual output from building subsystems 528 to determine an accuracy of the model.

Fault detection and diagnostics (FDD) layer 516 may be configured to provide on-going fault detection for building subsystems 528, building subsystem devices (i.e., building equipment), and control algorithms used by demand response layer 514 and integrated control layer 518. FDD layer 516 may receive data inputs from integrated control layer 518, directly from one or more building subsystems or devices, or from another data source. FDD layer 516 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 516 may be configured to output a specific identification of the faulty component or cause of the fault (e.g., loose damper linkage) using detailed subsystem inputs available at building subsystem integration layer 520. In other exemplary embodiments, FDD layer 516 is configured to provide “fault” events to integrated control layer 518 which executes control strategies and policies in response to the received fault events. According to some embodiments, FDD layer 516 (or a policy executed by an integrated control engine or business rules engine) may shut-down systems or direct control activities around faulty devices or systems to reduce energy waste, extend equipment life, or assure proper control response.

FDD layer 516 may be configured to store or access a variety of different system data stores (or data points for live data). FDD layer 516 may use some content of the data stores to identify faults at the equipment level (e.g., specific chiller, specific AHU, specific terminal unit, etc.) and other content to identify faults at component or subsystem levels. For example, building subsystems 528 may generate temporal (i.e., time-series) data indicating the performance of BMS 500 and the various components thereof. The data generated by building subsystems 528 may include measured or calculated values that exhibit statistical characteristics and provide information about how the corresponding system or process (e.g., a temperature control process, a flow control process, etc.) is performing in terms of error from its setpoint. These processes may be examined by FDD layer 516 to expose when the system begins to degrade in performance and alert a user to repair the fault before it becomes more severe.

### Control Device

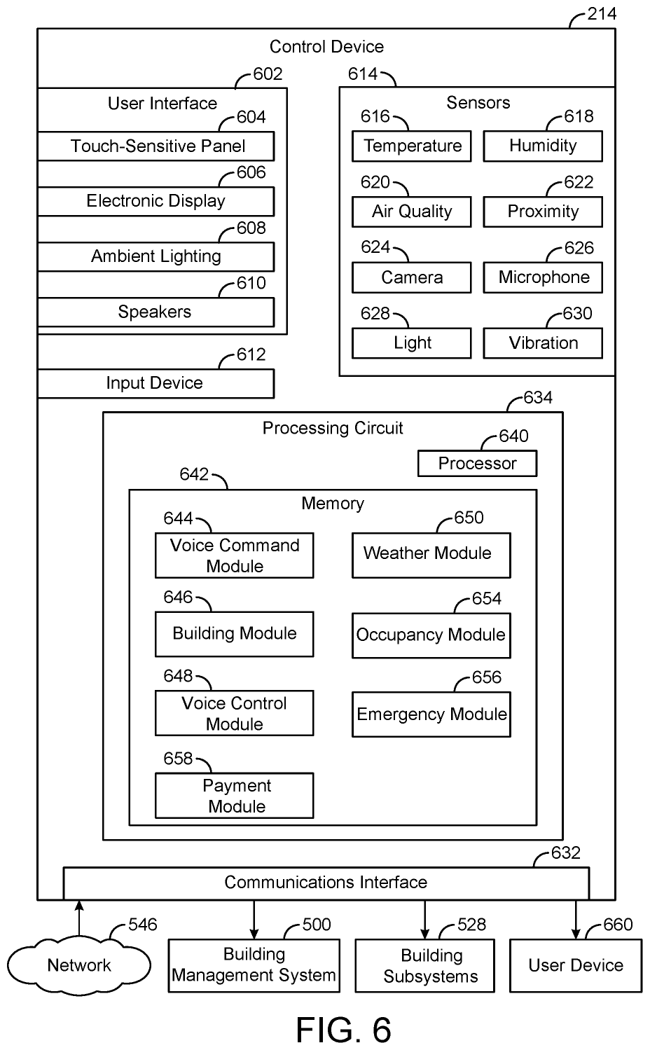

Referring now to FIG. 6, a block diagram illustrating control device 214 in greater detail is shown, according to some embodiments. Control device 214 is shown to include a variety of user interface devices 602 and sensors 614. User interface devices 602 may be configured to receive input from a user and provide output to a user in various forms. For example, user interface devices 602 are shown to include a touch-screen 604, electronic display 606, ambient lighting 608, speakers 610, and input device 612. Ambient lighting 608 may be an ambient light halo similar to those described in U.S. patent application Ser. No. 16/246,447, titled “Display Device with Halo,” filed Jan. 11, 2019, the entirety of which is incorporated by reference herein. In some embodiments, user interface devices 602 include a microphone configured to receive voice commands from a user, a keyboard or buttons, switches, dials, or any other user-operable input devices. In some embodiments, touch sensitive panel 604 is a touch-screen display configured to switch between multiple configurations. For example, touch sensitive panel 604 may start in a first configuration having a touch-sensitive numerical keypad to receive a user identification number from a user and switch to a second configuration after receiving the user identification number to accept a user fingerprint scan. It is contemplated that user interface devices 602 may include any type of device configured to receive input from a user and/or provide an output to a user in any of a variety of forms (e.g., touch, text, video, graphics, audio, vibration, etc.).

Sensors 614 may be configured to measure a variable state or condition of the environment in which control device 214 is installed. For example, sensors 614 are shown to include a temperature sensor 616, a humidity sensor 618, an air quality sensor 620, a proximity sensor 622, a camera 624, a microphone 626, a light sensor 628, and a vibration sensor 630. Air quality sensor 620 may be configured to measure any of a variety of air quality variables such as oxygen level, carbon dioxide level, carbon monoxide level, allergens, pollutants, smoke, etc. Proximity sensor 622 may include one or more sensors configured to detect the presence of people or devices proximate to control device 214. For example, proximity sensor 622 may include a near-field communications (NFC) sensor, a radio frequency identification (RFID) sensor, a Bluetooth sensor, a capacitive proximity sensor, a biometric sensor, or any other sensor configured to detect the presence of a person or device. Camera 624 may include a visible light camera, a motion detector camera, an infrared camera, an ultraviolet camera, an optical sensor, or any other type of camera. Light sensor 628 may be configured to measure ambient light levels. Vibration sensor 630 may be configured to measure vibrations from earthquakes or other seismic activity at the location of control device 214.

Still referring to FIG. 6, control device 214 is shown to include a communications interface 632 and a processing circuit 634. Communications interface 632 may include wired or wireless interfaces (e.g., jacks, antennas, transmitters, receivers, transceivers, wire terminals, etc.) for conducting data communications with various systems, devices, or networks. For example, communications interface 632 may include an Ethernet card and port for sending and receiving data via an Ethernet-based communications network and/or a Wi-Fi transceiver for communicating via a wireless communications network. Communications interface 632 may be configured to communicate via local area networks or wide area networks (e.g., the Internet, a building WAN, etc.) and may use a variety of communications protocols (e.g., BACnet, IP, LON, etc.).

Communications interface 632 may include a network interface configured to facilitate electronic data communications between control device 214 and various external systems or devices (e.g., communication network 546, building management system 500, building subsystems 528, user device 660, etc.) For example, control device 214 may receive information from BMS 500 indicating one or more measured states of the controlled building (e.g., security, temperature, humidity, electric loads, etc.). Further, control device 214 may communicate with a building intercom system and/or other voice-enabled security system. Communications interface 632 may receive inputs from BMS 500 or building subsystems 528 and may provide operating parameters (e.g., on/off decisions, set points, etc.) to BMS 500 or building subsystems 528. The operating parameters may cause BMS 500 to activate, deactivate, or adjust a set point for various types of home equipment or building equipment in communication with control device 214.

Processing circuit 634 is shown to include a processor 640 and memory 642. Processor 640 may be a general purpose or specific purpose processor, an application specific integrated circuit (ASIC), one or more field programmable gate arrays (FPGAs), a group of processing components, or other suitable processing components. Processor 640 may be configured to execute computer code or instructions stored in memory 642 or received from other computer readable media (e.g., CDROM, network storage, a remote server, etc.).

Memory 642 may include one or more devices (e.g., memory units, memory devices, storage devices, etc.) for storing data and/or computer code for completing and/or facilitating the various processes described in the present disclosure. Memory 642 may include random access memory (RAM), read-only memory (ROM), hard drive storage, temporary storage, non-volatile memory, flash memory, optical memory, or any other suitable memory for storing software objects and/or computer instructions. Memory 642 may include database components, object code components, script components, or any other type of information structure for supporting the various activities and information structures described in the present disclosure. Memory 642 may be communicably connected to processor 640 via processing circuit 634 and may include computer code for executing (e.g., by processor 640) one or more processes described herein. For example, memory 642 is shown to include a voice command module 644, a building module 646, a voice control module 648, an occupancy module 654, a weather module 650, and an emergency module 656, and a payment module 658. The functions of some of these modules is described in greater detail below.

Still referring to FIG. 6, memory 642 is shown to include a voice control module 658. Voice control module 658 may be configured to receive voice commands from a user via a microphone (e.g., microphone 626) and perform actions indicated by the voice commands. Voice control module 658 may interpret the voice commands to determine a requested action indicated by the voice commands. For example, a user may request that a nearby door is unlocked by speaking the voice command “unlock door.” Voice control module 658 may determine that the voice command is requesting that a door is unlocked and may automatically unlock the associated door. In some embodiments, voice control module 658 may determine a user identity using the voice command, prior to carrying out the voice command action.

In some embodiments, voice control module 658 is configured to listen for a trigger phrase (e.g., a device name, a wake-up phrase, etc.). The trigger phrase may be customizable and can be set to whatever phrase a user desires. Upon hearing the trigger phrase, voice control module 658 may listen for a voice command. Voice commands may include security and/or access changes controlled by control device 214 or other types of data recordation. In various embodiments, voice control module 658 may send requests to BMS 500 based on the spoken words.

Still referring to FIG. 6, memory 642 is shown to include a weather module 650. Weather module 650 may be configured to receive weather information and/or weather forecasts from a weather service via network 546. Weather module 650 may alert a user when a weather watch or warning concerning a weather phenomenon (e.g., storm, hail, tornado, hurricane, blizzard, etc.). Weather module 650 may control user interface 602 to automatically display weather warnings and important news.

Still referring to FIG. 6, memory 642 is shown to include a building module 646. Building module 646 may monitor conditions within a home or other building using information from sensors 614, user interface 602, user devices 660, network 546, BMS 500, and/or building subsystems 528.

In some embodiments, building module 646 interacts with BMS 500 and/or building subsystems 528 to determine the current status of building subsystems 528. For example, building module 646 may determine whether lights 542 are on or off, whether HVAC equipment 540 is active or inactive, and a current operating state for HVAC equipment 540 (e.g., heating, cooling, inactive, etc.). Building module 646 may determine a current state of security equipment 538 (e.g., armed, alarm detected, not armed, etc.), a current state of doors/locks (e.g., front door locked/unlocked, front door open/closed, garage door open/closed, etc.) and a current state of ICT equipment 536 (e.g., router connected to WAN, Internet connection active/inactive, telephone systems online/offline, etc.).

Building module 646 may report home/building conditions via user interface 602 and/or to user devices 660. Advantageously, this allows a user to monitor home/building conditions regardless of whether the user is physically present in the home/building. For example, a user can connect to control device 214 via a mobile device (e.g., user device 660, the user's phone, a vehicle system, etc.) while the user is away from the home/building to ensure that building module 646 is operating as intended.

In some embodiments, building module 646 collects data from control device 214, building subsystems 528 and/or BMS 500 and stores such information within memory 642 or in remote data storage. In some embodiments, building module 646 initially stores data in local memory 642 and exports such data to network storage periodically. For example, building module 646 may store a predetermined amount or duration of equipment performance data (e.g., 72 hours of operating data) in local memory 642 and backup the stored data to remote (e.g., cloud or network) storage at the end of a predetermined interval (e.g., at the end of each 72-hour interval). Advantageously, this may be used for building/home security purposes.

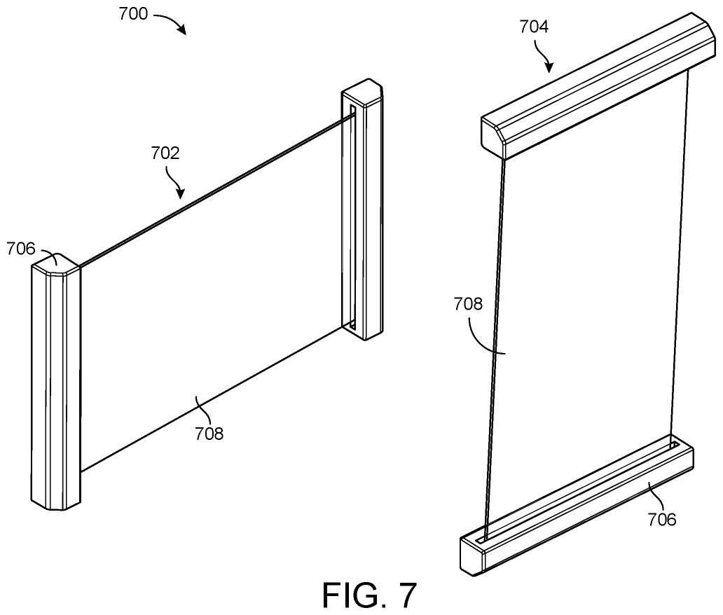

Turning now to FIG. 7, a non-limiting embodiment of a control device 700 is shown in both a horizontal orientation 702 and a vertical orientation 704. Control device 700 may be the same or similar to control device 214. Sensor/control bars 706 may be attached to one or both sides of a transparent display 708. The transparent display 708 may allow for the display of text and images but otherwise may allow the user to view an object (e.g., the wall the control device 700 is mounted on) through the transparent display 708.

Transparent display 708 may include a touch screen allowing user control by finger touch or stylus. The touch screen may use resistive touch technology, capacitive technology, surface acoustic wave technology, infrared grid technology, infrared acrylic projection, optical imaging technology, dispersive signal technology, acoustic pulse recognition, or other such transparent touch screen technologies known in the art. Many of these technologies allow for multi-touch responsiveness of the touch screen allowing registration of touch in two or even more locations at once. Transparent display 708 may be LCD technology, OLED technology or other such transparent touch screen technology.

Still referring to FIG. 7, the horizontal orientation 702 may be particularly conducive to landscape orientation as shown in the non-limiting embodiment of control device 700. The vertical orientation 704 may be particularly conducive to a portrait orientation. The sensor/control bars may contain the control and interface circuitry of the control device 700. This may be in the form of discrete components, integrated circuits, custom ASICs, FPGAs, wires, circuit boards, connectors, and wiring harnesses. The sensor/control bars 706 may contain various sensors such as temperature sensors, humidity sensors, CO2 sensors, CO sensors, smoke sensors, proximity sensors, ambient light sensors, and biometric sensors.

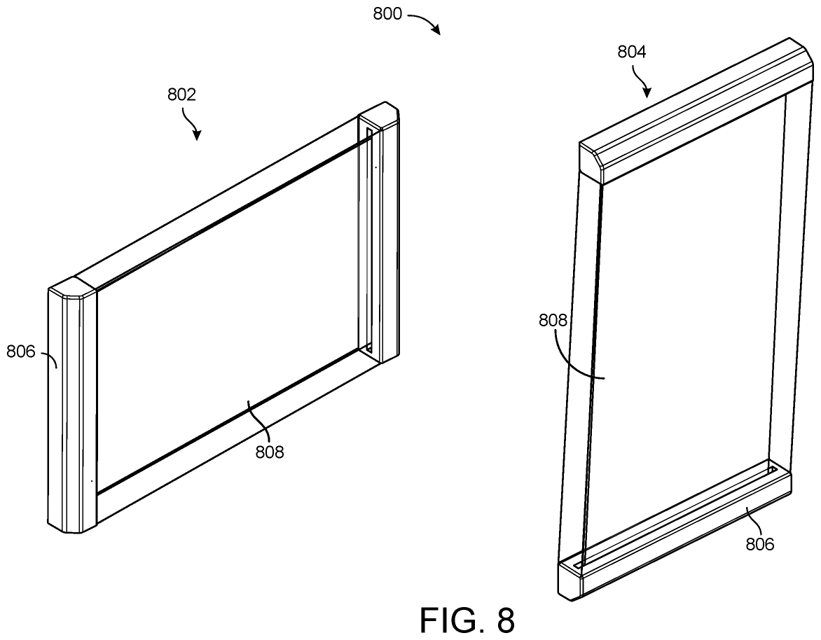

Turning now to FIG. 8, a non-limiting embodiment of a control device 800 is shown in both a horizontal orientation 802 and a vertical orientation 804. Control device 800 may be the same or similar to control device 214. Sensor/control bars 806 may be attached to all sides of a transparent display 808 (e.g., sensor/control bars 806 may frame transparent display 808). The transparent display 808 may allow for the display of text and images but otherwise may allow the user to view an object (e.g., the wall the control device 800 is mounted on) through the transparent display 808.

Transparent display 808 may include a touch screen allowing user control by finger touch or stylus. The touch screen may use resistive touch technology, capacitive technology, surface acoustic wave technology, infrared grid technology, infrared acrylic projection, optical imaging technology, dispersive signal technology, acoustic pulse recognition, or other such transparent touch screen technologies known in the art. Many of these technologies allow for multi-touch responsiveness of the touch screen allowing registration of touch in two or even more locations at once. Transparent display 808 may be LCD technology, OLED technology or other such transparent touch screen technology.

Still referring to FIG. 8, the horizontal orientation 802 may be particularly conducive to landscape orientation as shown in the non-limiting embodiment of control device 800. The vertical orientation 804 may be particularly conducive to a portrait orientation. The sensor/control bars 806 may contain the control and interface circuitry of the control device 800. This may be in the form of discrete components, integrated circuits, custom ASICs, FPGAs, wires, circuit boards, connectors, and wiring harnesses. The sensor/control bars 806 may contain various sensors such as temperature sensors, humidity sensors, CO2 sensors, CO sensors, smoke sensors, proximity sensors, ambient light sensors, and biometric sensors.

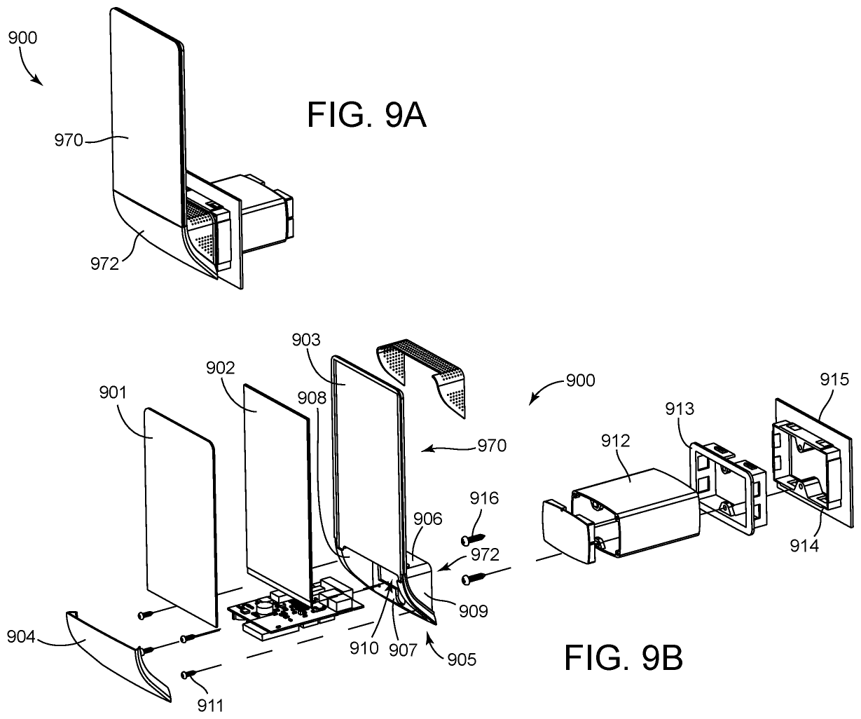

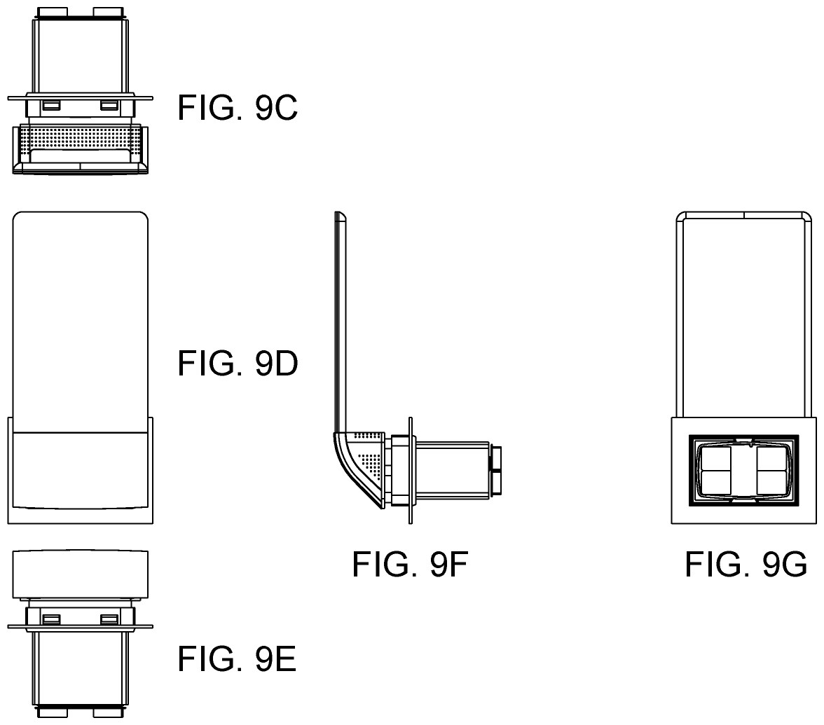

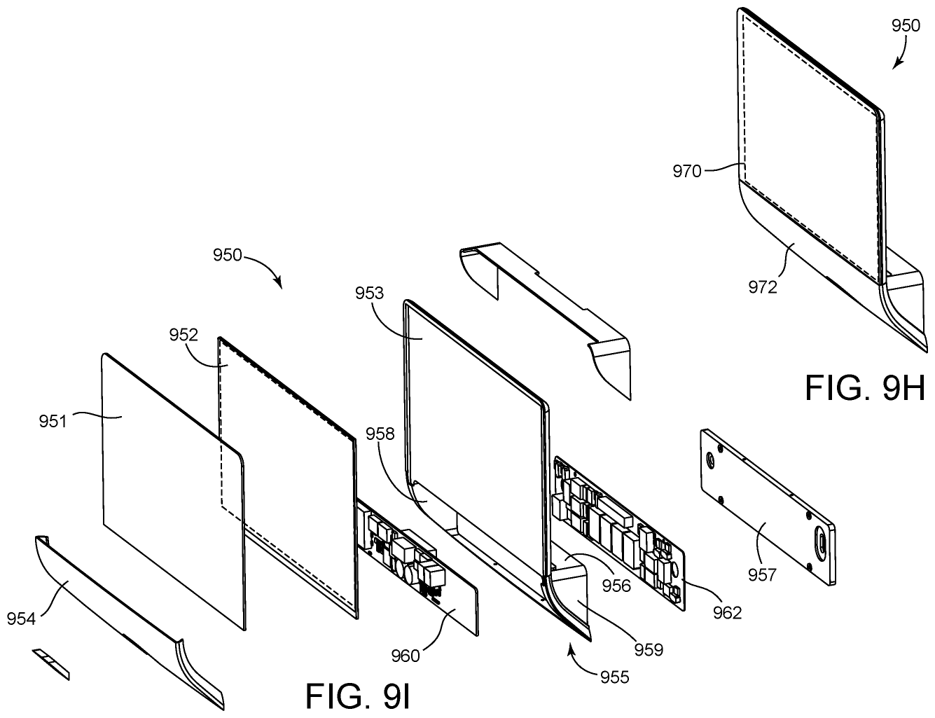

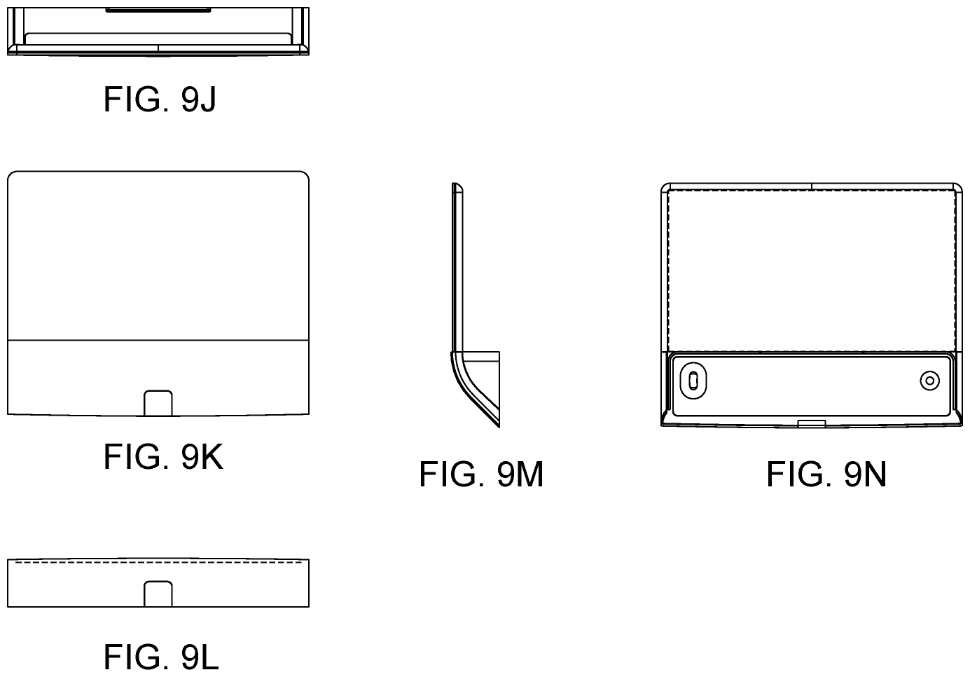

Referring now to FIGS. 9A-9G, several drawings of an installation assembly 900 for a control device are shown, according to some embodiments. In some situations, the control device may refer to control device 214. FIG. 9A is a perspective view of installation assembly 900 in an assembled state. FIG. 9B is an exploded view of installation assembly 900. FIG. 9C is a top view of installation assembly 900. FIG. 9D is a front view of installation assembly 900. FIG. 9E is a bottom view of installation assembly 900. FIG. 9F is a side view of installation assembly 900. FIG. 9G is a rear view of installation assembly 900.

As shown in FIG. 9B, installation assembly 900 may include several layers 901, 902, and 903 which combine to form transparent display 970. For example, front layer 901 may be a protective panel, middle layer 902 may be a touchscreen panel (e.g., an OLED display with a touch-sensitive panel), and rear layer 903 may be a protective housing layer. However, it should be understood that transparent display 970 may include any number of layers which may be arranged in any order and is not limited to the configuration shown in FIG. 9B. In some embodiments, rear layer 903 is part of the main housing for control device 214, which extends from housing 972. For example, a bottom edge of rear layer 903 is shown attaching to an upper edge of housing 972. Transparent display 970 may be cantilevered from housing 972 such that only the bottom edge of rear layer 903 is constrained.

Housing 972 is shown to include a front panel 904 and a housing body 905. A top edge of front panel 904 may be adjacent to the lower edge of transparent display 970. Front panel 904 is shown curving downward and rearward from the top edge toward the mounting surface. Housing body 905 may include a top surface 906, a rear surface 907, and opposing side surfaces 908-909. The lower edge of front panel 904 may be substantially coplanar with rear surface 907. Rear surface 907 may be substantially parallel to the mounting surface (e.g., the wall upon which the control device is mounted) and located immediately in front of the mounting surface.

In some embodiments, housing 972 is installed in front of an electrical gang box 912, which may be recessed into the mounting surface (e.g., located inside the wall). Housing body 905 may attach to gang box 912 via screws or other connectors 911 to secure housing body 905 to gang box 912. Gang box 912 may be secured to one or more frames 913-914. In some embodiments, frame 913 is located in front of the mounting surface, whereas frame 914 is located behind the mounting surface. Frame 914 is shown to include a perimeter flange 915 which may extend behind the mounting surface. Flange 915 may be larger than the opening in the mounting surface to prevent frame 914 from being pulled out of the mounting surface. Frames 913-914 may be coupled together via a fitted connection (e.g., snaps, clips, etc.) and/or via mechanical fasteners 916.

In some embodiments, rear surface 907 includes an opening 910, which connects the internal volume of housing body 905 with the internal volume of gang box 912. Electronic components within housing body 905 may extend through opening 910 and into gang box 912. For example, assembly 900 is shown to include a circuit board 917. Circuit board 917 may include one or more sensors (e.g., a temperature sensor, a humidity sensor, etc.), communications electronics, a processing circuit, and/or other electronics configured to facilitate the functions of control device 214. Circuit board 917 may extend through opening 910 and into gang box 912.

Circuit board 917 may connect to a wire terminal board, which can slide forward and rearward within gang box 912. The wire terminal board attaches to wires within the wall (e.g., power wires, data wires, etc.) and to circuit board 917. For example, a rear side of the wire terminal board may include wire terminals or other connectors configured to receive wires from within the wall. A front side of the wire terminal board may include wire terminals or other connectors configured to receive wires extending from circuit board 917. During installation, the wire terminal board is connected to the wires within the wall and slid into gang box 912. Circuit board 917 is then connected to the front side of the wire terminal board when the control device is mounted on the wall.

In some embodiments, circuit board 917 is oriented substantially perpendicular to the mounting surface. For example, circuit board 917 may be oriented perpendicular to the wall upon which the control device is mounted and may extend through opening 910 into the wall. Advantageously, opening 910 allows circuit board 917 and other electronic components to be located within housing body 905 and/or within gang box 912. The arrangement shown in FIGS. 9A-9G provides more space for such electronic components by recessing some or all of the electronic components into the mounting surface.

Referring now to FIGS. 9H-9N, several drawings of an installation assembly 950 for the control device are shown, according to some embodiments. In some embodiments, the control device may be the same or similar to control device 214. FIG. 9H is a perspective view of installation assembly 950 in an assembled state. FIG. 9I is an exploded view of installation assembly 950. FIG. 9J is a top view of installation assembly 950. FIG. 9K is a front view of installation assembly 950. FIG. 9L is a bottom view of installation assembly 950. FIG. 9M is a side view of installation assembly 950. FIG. 9N is a rear view of installation assembly 950.

As shown in FIG. 9I, installation assembly 950 may include several layers 951, 952, and 953 which combine to form transparent display 970. For example, front layer 951 may be a protective panel, middle layer 952 may be a touchscreen panel (e.g., an OLED display with a touch-sensitive panel), and rear layer 953 may be a protective housing layer. However, it should be understood that transparent display 970 may include any number of layers which may be arranged in any order and is not limited to the configuration shown in FIG. 9I. In some embodiments, rear layer 953 is part of the main housing for control device 214, which extends from housing 972. For example, a bottom edge of rear layer 953 is shown attaching to an upper edge of housing 972. Transparent display 970 may be cantilevered from housing 972 such that only the bottom edge of rear layer 953 is constrained.

Housing 972 is shown to include a front panel 954 and a housing body 955. A top edge of front panel 954 may be adjacent to the lower edge of transparent display 970. Front panel 954 is shown curving downward and rearward from the top edge toward the mounting surface. Housing body 955 may include a top surface 956 and opposing side surfaces 958-959. A mounting plate 957 may form the rear surface of housing body 955. The lower edge of front panel 954 may be substantially coplanar with mounting plate 957. Mounting plate 957 may be substantially parallel to the mounting surface (e.g., the wall upon which the control device is mounted) and located immediately in front of the mounting surface. Holes in mounting plate 957 allow wires from within the wall (e.g., power wires, data wires, etc.) to extend through mounting plate 957.

In some embodiments, mounting plate 957 is attached to an outward-facing surface of the wall or other mounting surface. Housing 972 may be configured to attach to an outward-facing surface of mounting plate 957 such that housing 972 is located in front of the mounting surface (i.e., not recessed into the mounting surface). In other embodiments, control device 214 is installed in front of a recess in the mounting surface. A portion of housing 972 may be recessed into the mounting surface. For example, mounting plate 957 may be recessed into the mounting surface.

Housing body 955 may contain various electronic components. For example, control device 214 is shown to include a first circuit board 960 and a second circuit board 962. Circuit boards 960-962 may include one or more sensors (e.g., a temperature sensor, a humidity sensor, etc.), communications electronics, a processing circuit, and/or other electronics configured to facilitate the functions of the control device. In some embodiments, circuit boards 960-962 are oriented substantially parallel to the mounting surface. For example, circuit boards 960-962 may be offset from one another in a direction perpendicular to the surface and oriented substantially parallel to the mounting surface. In other embodiments, one or both of circuit boards 960-962 may be oriented substantially perpendicular to the mounting surface, as shown in FIGS. 9A-9G.

In some embodiments, circuit board 962 functions as a wire terminal board. For example, the wires extending through mounting plate 957 may attach to wire terminals or other connectors on a rear surface of circuit board 962. Wires extending from circuit board 960 may attach to wire terminals or other connectors on a front surface of circuit board 962. During installation, mounting plate 957 may be attached to the mounting surface. Circuit board 962 may then be attached to mounting plate 957. The remaining components of assembly 950 may form an integrated unit and may be attached to circuit board 962 and/or mounting plate 957. The arrangement shown in FIGS. 9H-9N provides more space for electronic components within housing body 955 relative to the arrangement shown in FIGS. 9A-9G. Accordingly, it may be unnecessary to recess circuit boards 960-962 into the mounting surface.

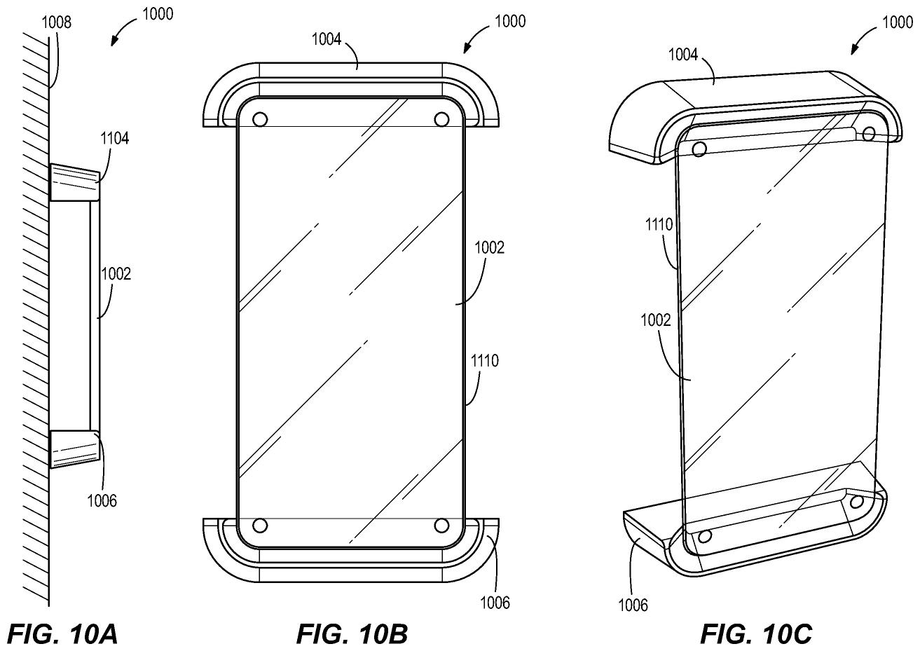

Referring now to FIGS. 10A-28C, several alternative physical configurations of control device 214 are shown, according to various exemplary embodiments. The alternative configurations illustrated in FIGS. 10A-28C are labeled as user control devices 1000-2800 for clarity. However, it should be understood that user control devices 1000-2800 are not necessarily distinct from control device 214 and that control device 214 can be adapted to have any of the physical configurations shown and described herein.

Referring particularly to FIGS. 10A-10C, a user control device 1000 is shown, according to some embodiments. User control device 1000 is shown to include a touch-sensitive display 1002, a first sensor bar 1004 located at a first end of display 1002, a second sensor bar 1006 located at a second end of display 1002, and an ambient lighting frame 1010 around display 1002. Display 1002 may be the same or similar to transparent display 970 as previously described. Sensor bars 1004-1006 may house a variety of sensors and/or electronic components and may be similar to housing 972 as previously described. Sensor bars 1004-1006 may attach to a wall 1008 to provide support for display 1002 on both ends of display 1002.

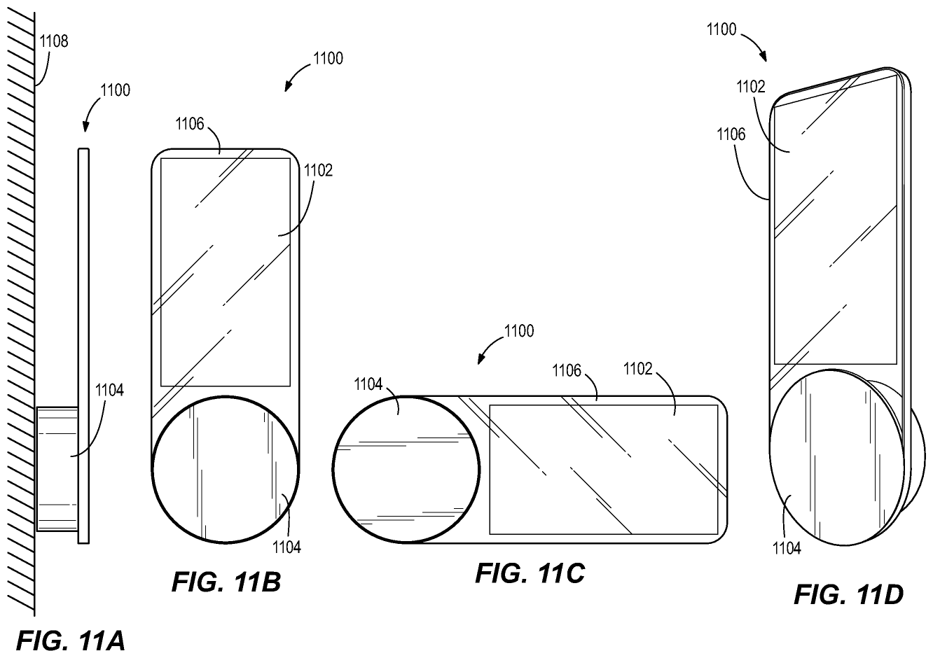

Referring now to FIGS. 11A-11D, a user control device 1100 is shown, according to some embodiments. User control device 1100 is shown to include a touch-sensitive display 1102, a housing 1104, and an ambient lighting frame 1106 around display 1102. Display 1102 may be the same or similar to transparent display 970 as previously described. Housing 1104 may be similar to housing 972 as previously described. In some embodiments, housing 1104 is attached to a lower end of display 1102 as shown in FIG. 11B. In other embodiments, housing 1104 is attached to a side of display 1102 as shown in FIG. 11C. User control device 1100 may be configured to rotate about a central axis passing through housing 1104 between the positions shown in FIGS. 11B-11C. In some embodiments, housing 1104 is touch sensitive to provide supplemental user interactivity and control options.

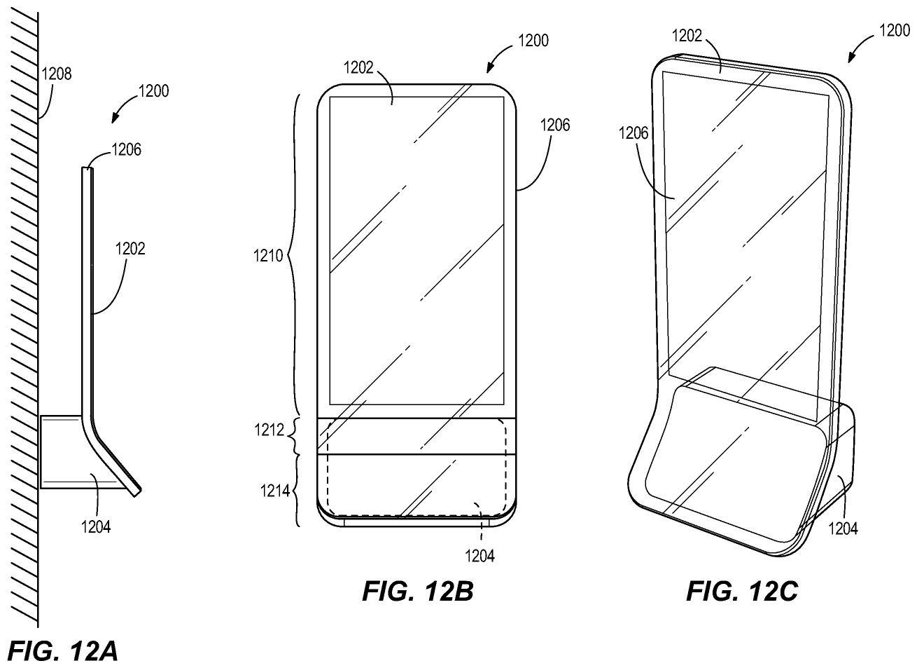

Referring now to FIGS. 12A-12C, a user control device 1200 is shown, according to some embodiments. User control device 1200 is shown to include a touch-sensitive display 1202, a housing 1204, and an ambient lighting frame 1206 around display 1202. Display 1202 may be the same or similar to transparent display 970 as previously described. In some embodiments, display 1202 is positioned in front of housing 1204 such that housing 1204 is completely hidden between display 1202 and wall 1208. Display 1202 may include a first planar portion 1210, a second planar portion 1214, and a curved portion connecting planar portions 1210 and 1214. Display 1202 may be configured to present a continuous visual image along portions 1210-1214.

Housing 1204 may be similar to housing 972 as previously described. In some embodiments, housing 1204 is attached to each of portions 1210-1214 of display 1202. In other embodiments, housing 1204 may attach to only a subset of portions 1210-1214. Housing 1204 may have a curved profile configured to match the curve of display 1202. In some embodiments, housing 1204 is recessed or partially-recessed into wall 1208. In other embodiments, housing 1204 is completely external to wall 1208.

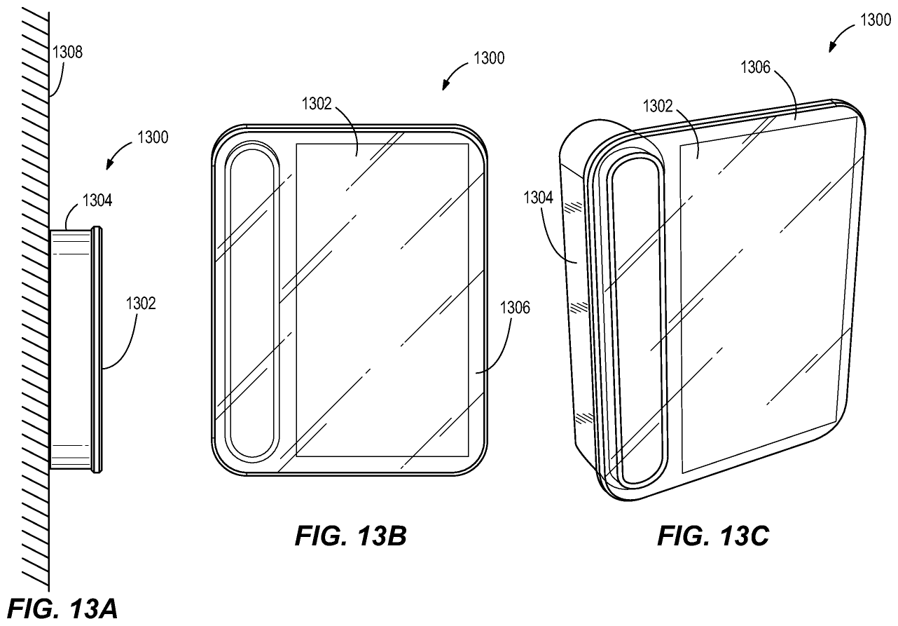

Referring now to FIGS. 13A-13C, a user control device 1300 is shown, according to some embodiments. User control device 1300 is shown to include a touch-sensitive display 1302, a housing 1304, and an ambient lighting frame 1306 around display 1302. Display 1302 may be the same or similar to transparent display 970 as previously described. In some embodiments, display 1302 is positioned in front of housing 1304 such that housing 1304 is completely hidden between display 1302 and wall 1308. Housing 1304 may be similar to housing 972 as previously described. In some embodiments, housing 1304 is recessed or partially-recessed into wall 1308. In other embodiments, housing 1304 is completely external to wall 1308.

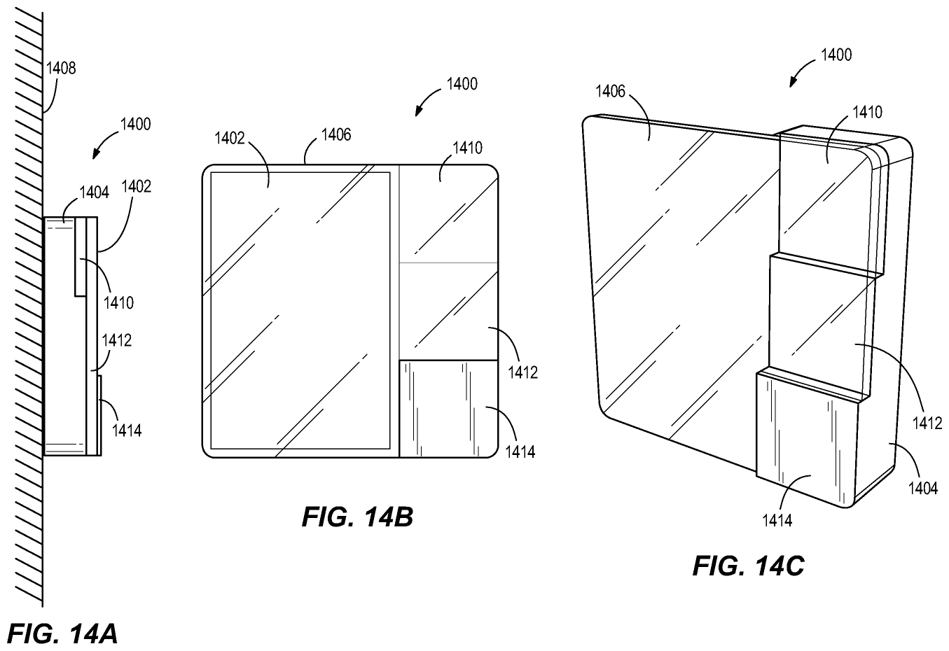

Referring now to FIGS. 14A-14C, a user control device 1400 is shown, according to some embodiments. User control device 1400 is shown to include a touch-sensitive display 1402, a housing 1404, and an ambient lighting frame 1406 around display 1402. Display 1402 may be the same or similar to transparent display 970 as previously described. In some embodiments, display 1402 is positioned partially in front of housing 1404 such that housing 1404 is partially hidden between display 1402 and wall 1408.

Housing 1404 may be similar to housing 972 as previously described. In some embodiments, housing 1404 includes a plurality of steps 1410, 1412, and 1414, each of which is spaced by a different distance from wall 1408. Display 1402 may be positioned in front of a subset of steps 1410-1414. For example, display 1402 is shown positioned in front of steps 1410 and 1412, but not step 1414. In some embodiments, display 1402 contacts a front surface of step 1412. A gap may exist between display 1402 and the front surface of step 1410. Step 1414 may protrude frontward of display 1402 such that display 1402 is positioned between the front surface of step 1414 and wall 1408. In some embodiments, housing 1404 is recessed or partially-recessed into wall 1408. In other embodiments, housing 1404 is completely external to wall 1408.

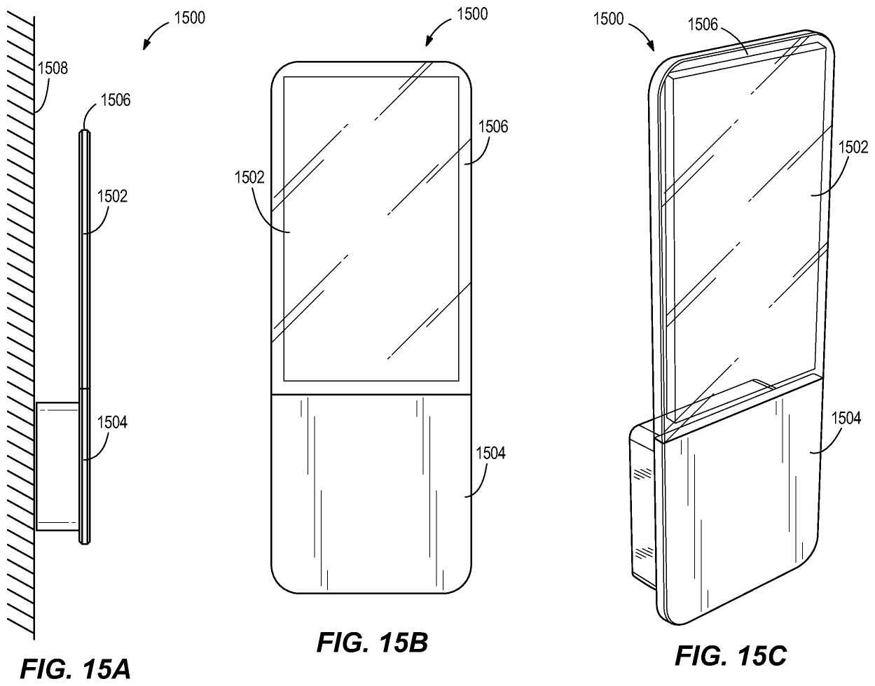

Referring now to FIGS. 15A-15C, a user control device 1500 is shown, according to some embodiments. User control device 1500 is shown to include a touch-sensitive display 1502, a housing 1504, and an ambient lighting frame 1506 around display 1502. Display 1502 may be the same or similar to transparent display 970 as previously described. In some embodiments, housing 1504 is attached to an end (e.g., a lower surface) of display 1502 and connects display 1502 to wall 1508. Housing 1504 may be similar to housing 972 as previously described. In some embodiments, housing 1504 is recessed or partially-recessed into wall 1508. In other embodiments, housing 1504 is completely external to wall 1508.

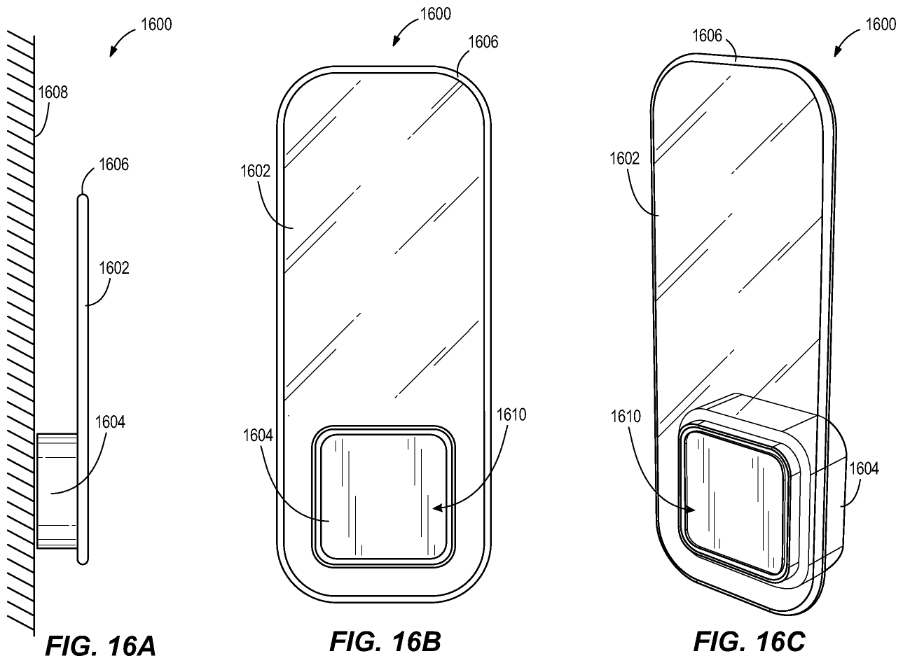

Referring now to FIGS. 16A-16C, a user control device 1600 is shown, according to some embodiments. User control device 1600 is shown to include a touch-sensitive display 1602, a housing 1604, and an ambient lighting frame 1606 around display 1602. Display 1602 may be the same or similar to transparent display 970 as previously described. In some embodiments, display 1602 is attached to a rear surface of display 1602 such that housing 1604 is positioned between display 1602 and wall 1608. Display 1602 may include an opening 1610 such that a front surface of housing 1604 is visible through opening 1610. Housing 1604 may be similar to housing 972 as previously described. In some embodiments, housing 1604 is touch sensitive to provide supplemental user interactivity and control options. In some embodiments, housing 1604 is recessed or partially-recessed into wall 1608. In other embodiments, housing 1604 is completely external to wall 1608.

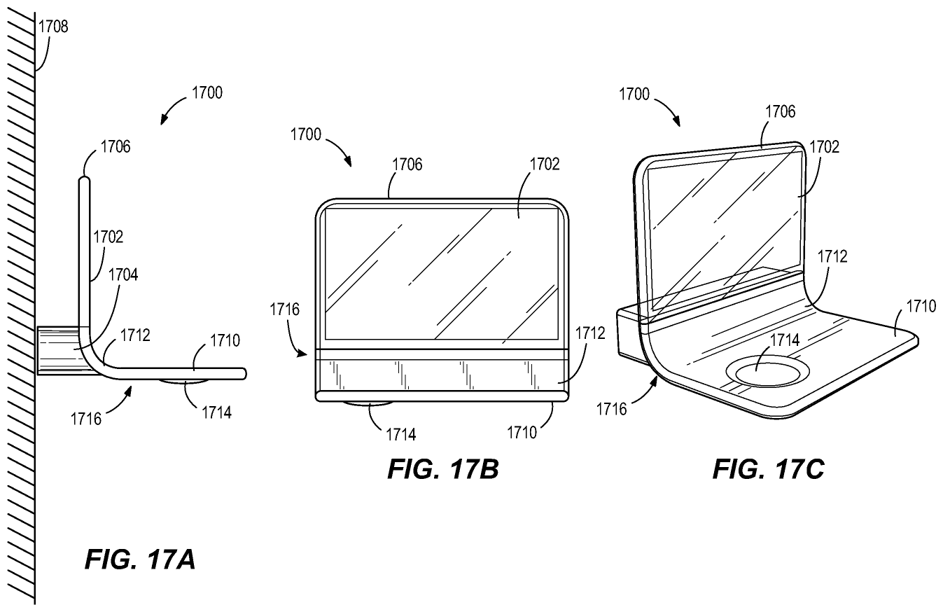

Referring now to FIGS. 17A-17C, a user control device 1700 is shown, according to some embodiments. User control device 1700 is shown to include a touch-sensitive display 1702, a housing 1704, an ambient lighting frame 1706 around display 1702, and a shelf 1716 attached to a lower end of display 1702. Display 1702 may be the same or similar to transparent display 970 as previously described. In some embodiments, shelf 1716 is attached to an end (e.g., a lower surface) of display 1702 and connects display 1702 to housing 1704. Shelf 1716 is shown to include a substantially planar portion 1710 and a curved portion 1712. Planar portion 1710 may be oriented substantially perpendicular to the front surface of display 1702. Curved portion 1712 may connect planar portion 1710 to display 1702. In some embodiments, planar portion 1710 includes a recess 1714 in an upper surface of planar portion 1710. In some embodiments, planar portion 1710 includes hooks attached to a lower surface of planar portion 1710. The hook may be used, for example, to hold key chains hanging from the hooks below user control device 1700.

Housing 1704 may be similar to housing 972 as previously described. In some embodiments, housing 1704 attaches to curved portion 1712 and connects shelf 1716 to wall 1708. In other embodiments, housing 1704 may attach to a rear surface of display 1702 in addition to or in place of attaching to shelf 1716. In some embodiments, housing 1704 is recessed or partially-recessed into wall 1708. In other embodiments, housing 1704 is completely external to wall 1708.

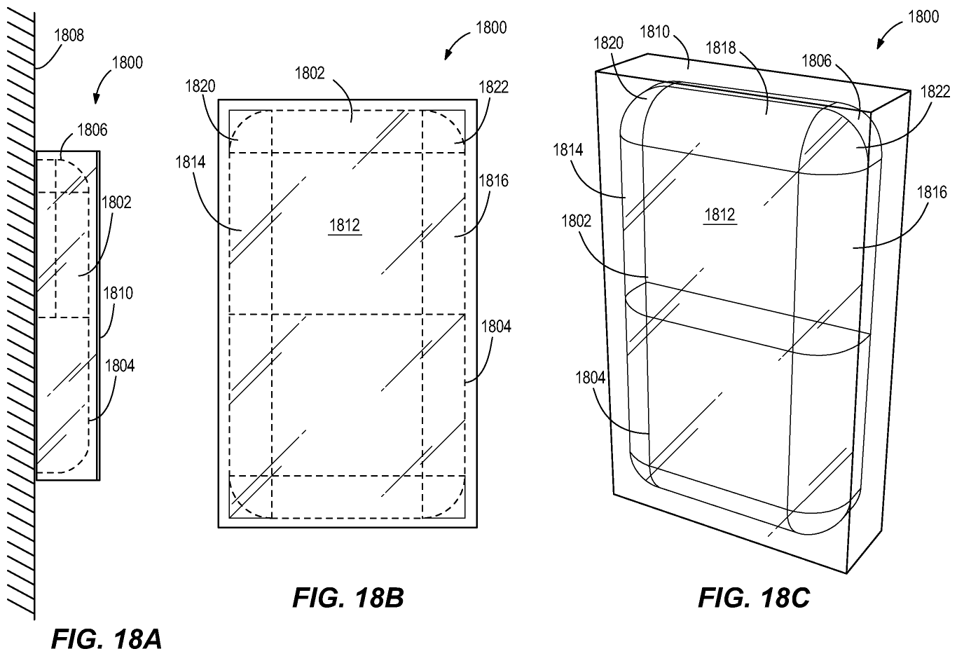

Referring now to FIGS. 18A-18C, a user control device 1800 is shown, according to some embodiments. User control device 1800 is shown to include a solid transparent block 1810, a touch-sensitive display 1802 floating within block 1810, a housing 1804 floating within block 1810, and an ambient lighting frame 1806 around display 1802. In some embodiments, block 1810 is attached to wall 1808 along an entire rear surface of block 1810. In other embodiments, block 1810 is substantially hollow and contacts wall 1808 along a perimeter of block 1810. Display 1802 and housing 1804 may be suspended (i.e., floating) within block 1810.

Display 1802 may be the same or similar to transparent display 970 as previously described. In some embodiments, display 1802 is curved. For example, display 1802 is shown to include a planar frontal portion 1812, a curved left side portion 1814, a curved right side portion 1816, a curved top portion 1818, and curved corner portions 1820-1822. Side portions 1814-1816 may be curved around side edges, whereas top portion 1818 may be curved around a top edge. Corner portions 1820-1822 may be curved around both the side edges and the top edge. In some embodiments, display 1820 is configured to present a continuous visual image spanning each of portions 1812-1822. In some embodiments, housing 1804 is attached to an end (e.g., a lower surface) of display 1802. Housing 1804 and ambient lighting frame 1806 may be the same or similar to housing 972 and ambient lighting frame 108 as previously described.

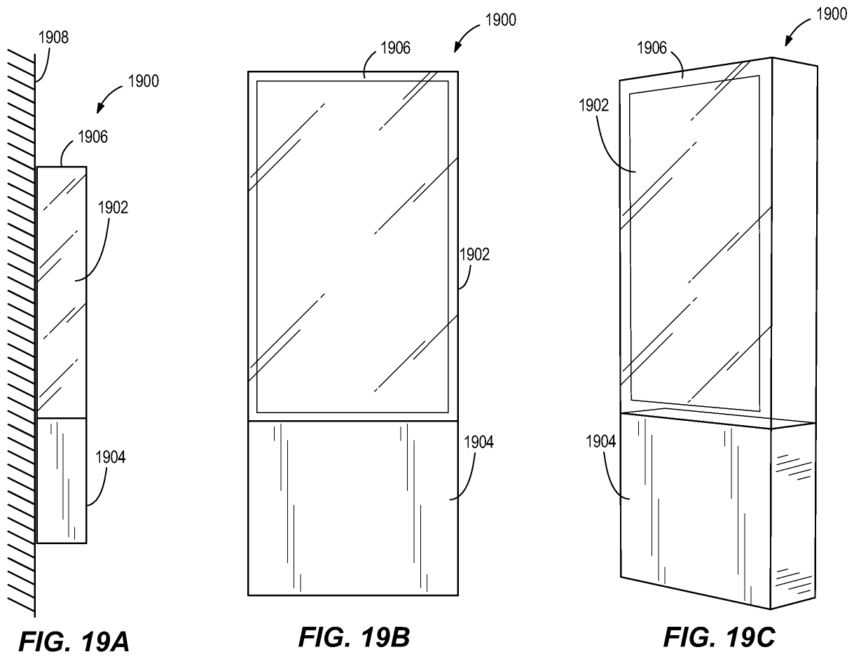

Referring now to FIGS. 19A-19C, a user control device 1900 is shown, according to some embodiments. User control device 1900 is shown to include a touch-sensitive display 1902, a housing 1904, and an ambient lighting frame 1906 around display 1902. Display 1902 may be the same or similar to transparent display 970 as previously described. In some embodiments, housing 1904 is attached to an end (e.g., a lower surface) of display 1902 and connects display 1902 to wall 1908. In other embodiments, display 1902 is directly attached to wall 1908 along a rear surface of display 1902. Housing 1904 may be similar to housing 972 as previously described. In some embodiments, housing 1904 is recessed or partially-recessed into wall 1908. In other embodiments, housing 1904 is completely external to wall 1908.

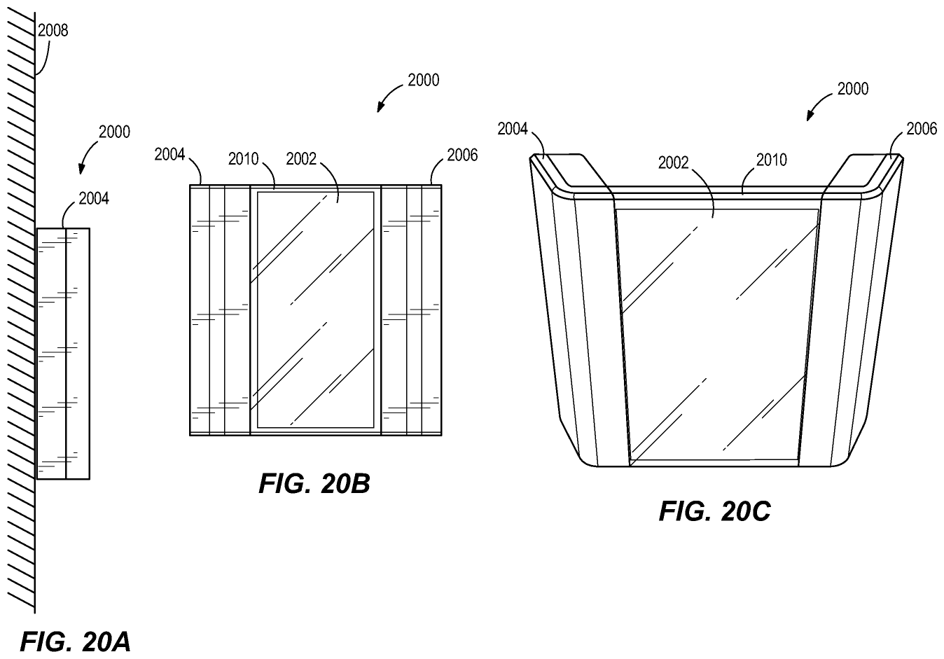

Referring now to FIGS. 20A-20C, a user control device 2000 is shown, according to some embodiments. User control device 2000 is shown to include a touch-sensitive display 2002, a first sensor bar 2004 located at a first end of display 2002, a second sensor bar 2006 located at a second end of display 2002, and an ambient lighting frame 2010 around display 2002. Display 2002 may be the same or similar to transparent display 970 as previously described. Sensor bars 2004-2006 may house a variety of sensors and/or electronic components and may be similar to housing 972 as previously described. Sensor bars 2004-2006 may attach to a wall 2008 to provide support for display 2002 on both ends of display 2002.

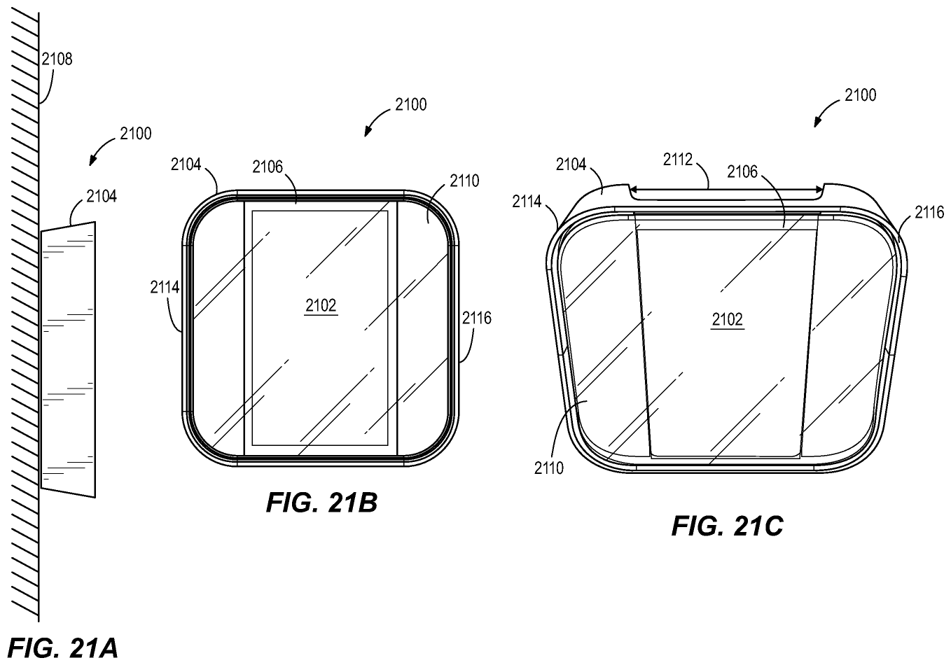

Referring now to FIGS. 21A-21C, a user control device 2100 is shown, according to some embodiments. User control device 2100 is shown to include a touch-sensitive display 2102 mounted within a frame 2104 and a panel 2110 overlaying touch-sensitive display 2102 and a portion of frame 2104. Display 2102 may be the same or similar to transparent display 970 as previously described. In some embodiments, display 2102 is configured to display visual media, whereas panel 2110 is a touch-sensitive panel. The combination of display 2102 and panel 2110 may provide touchscreen display functionality. In some embodiments, user control device 2100 includes an ambient lighting frame 2106 around display 2102.

Housing 2104 may be similar to housing 972 as previously described. For example, housing 2104 may house a variety of sensors and/or electronic components. In some embodiments, housing 2104 includes a first end 2114 along a first edge of display 2102 and a second end 2116 along a second edge of display 2102. Ends 2114-2116 may attach to wall 2108 to provide support for display 2102 on both ends of display 2102. Housing 2104 is shown to include an empty space 2112 or recess between ends 2114-2116 behind display 2102. Space 2112 may allow wall 2108 to be seen through display 2102. In some embodiments, housing 2104 extends from wall 2108 at least as far as display 2102 such that display 2102 is not visible from the side (as shown in FIG. 21A).

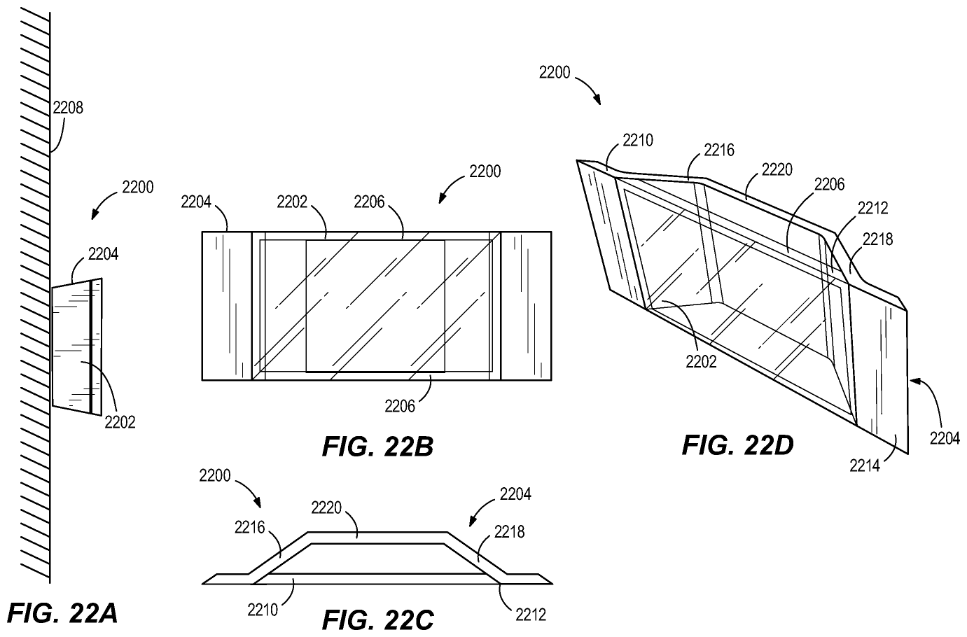

Referring now to FIGS. 22A-22D, a user control device 2200 is shown, according to some embodiments. User control device 2200 is shown to include a touch-sensitive display 2202, a housing 2204, and an ambient lighting frame 2206. Display 2202 may be the same or similar to transparent display 970 as previously described. Housing 2204 may connect to opposite ends 2210-2212 of display 2202 and may be the same or similar to housing 972 as previously described. Ambient lighting frame 2206 may extend along one or more edges of display 2202 (e.g., a top edge and a bottom edge).

In some embodiments, a front surface 2214 of housing 2204 is substantially coplanar with a front surface of display 2202. Angled portions 2216-2218 of housing 2204 may connect to front surface 2214 and may extend rearward of display 2202. Angled portions 2216-2218 connect to opposite sides of a planar portion 2220 of housing 2204 positioned behind display 2202. Planar portion 2220 may be substantially parallel to display 2202 and positioned behind display 2202. In some embodiments, angled portions 2216-2218 and planar portion 2220 are recessed into wall 2208. In other embodiments, housing 2204 is completely external to wall 2208.

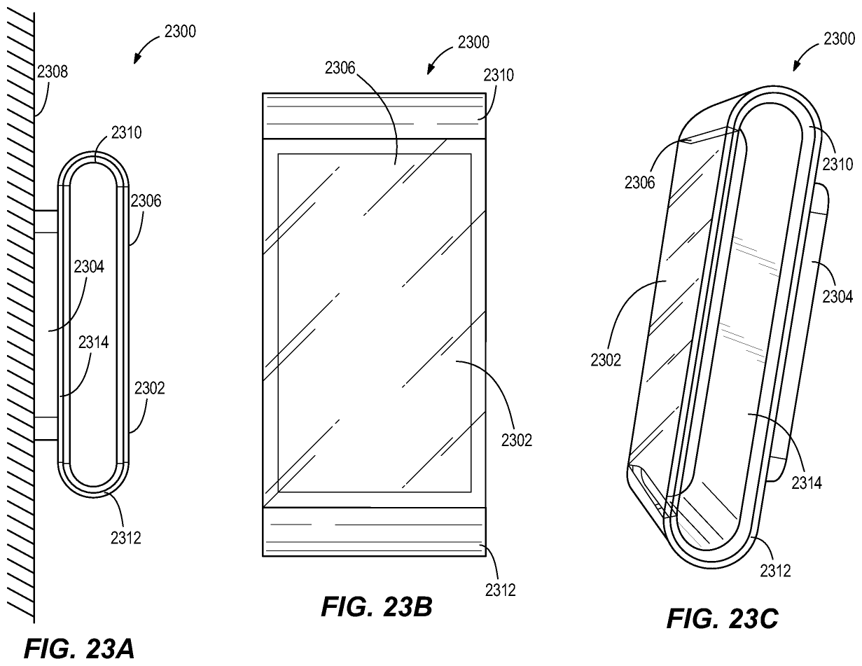

Referring now to FIGS. 23A-23C, a user control device 2300 is shown, according to some embodiments. User control device 2300 is shown to include a touch-sensitive display 2302, a plurality of frame panels 2310-2314 coupled to display 2302, a housing 2304 connecting frame panels 2310-2314 with a wall 2308, and an ambient lighting frame 2306 around display 2302. Display 2302 may be the same or similar to transparent display 970 as previously described. Frame panel 2310 may be a curved panel attaching to a first end of display 2302 (e.g., a top end) and a first end (e.g., a top end) of panel 2314. Similarly, frame panel 2312 may be a curved panel attaching to a second end of display 2302 (e.g., a bottom end) and a second end (e.g., a bottom end) of panel 2314. Panel 2314 may be positioned behind display 2302 and may attach to housing 2304. Housing 2304 may be the same or similar to housing 972 as previously described.

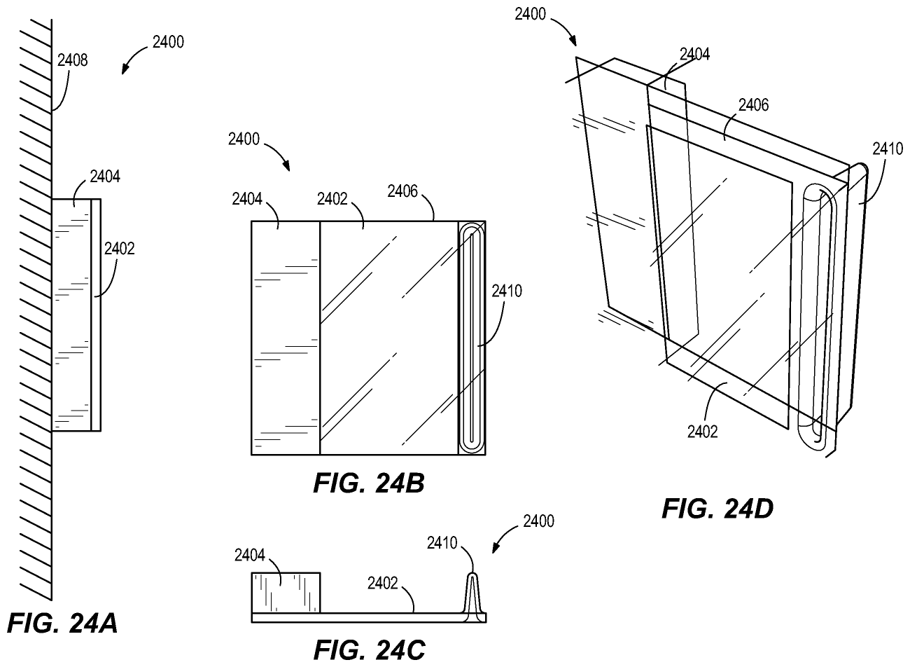

Referring now to FIGS. 24A-24D, a user control device 2400 is shown, according to some embodiments. User control device 2400 is shown to include a touch-sensitive display 2402, a housing 2404, an ambient lighting frame 2406 around display 2402, and a support leg 2410. Display 2402 may be the same or similar to transparent display 970 as previously described. In some embodiments, housing 2404 is attached to an end (e.g., a side surface) of display 2402 and connects display 2402 to wall 2408. Housing 2404 may be similar to housing 972 as previously described. In some embodiments, housing 2404 is recessed or partially-recessed into wall 2408. In other embodiments, housing 2404 is completely external to wall 2408. Support leg 2410 may connect to an end of display 2402 opposite housing 2404 and may contact the front surface of wall 2408 to provide support for display 2402.

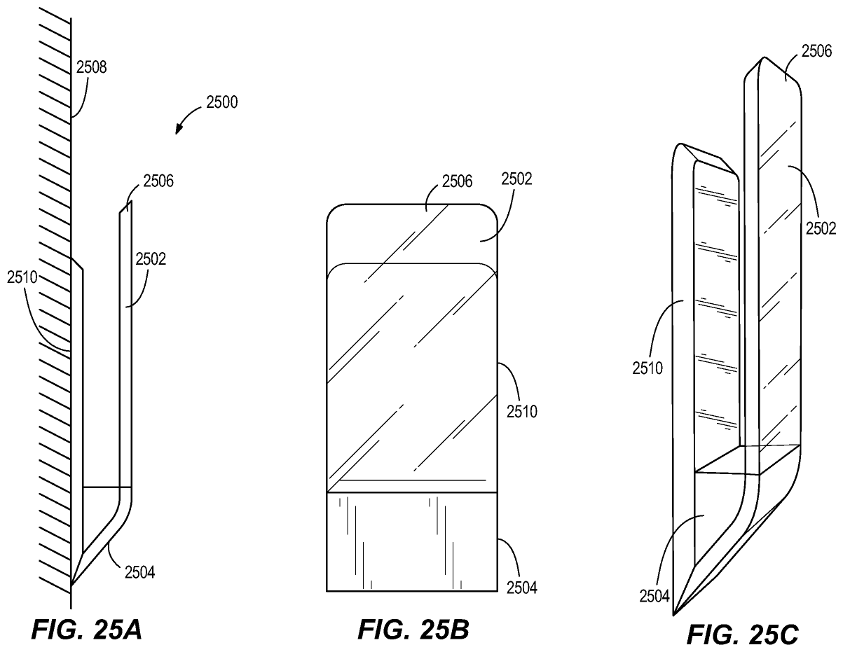

Referring now to FIGS. 25A-25C, a user control device 2500 is shown, according to some embodiments. User control device 2500 is shown to include a touch-sensitive display 2502, a housing 2504, an ambient lighting frame 2506 around display 2502, and a rear panel 2510. Display 2502 may be the same or similar to transparent display 970 as previously described. In some embodiments, housing 2504 is attached to an end (e.g., a lower surface) of display 2502 and connects display 2502 to rear panel 2510. Housing 2504 may be similar to housing 972 as previously described. Rear panel 2510 may be positioned behind display 2502 (e.g., between display 2502 and wall 2508) and may attach to both housing 2504 and wall 2508. In some embodiments, housing 2504 and rear panel 2510 are recessed or partially-recessed into wall 2508. In other embodiments, housing 2504 and rear panel 2510 are completely external to wall 2508.

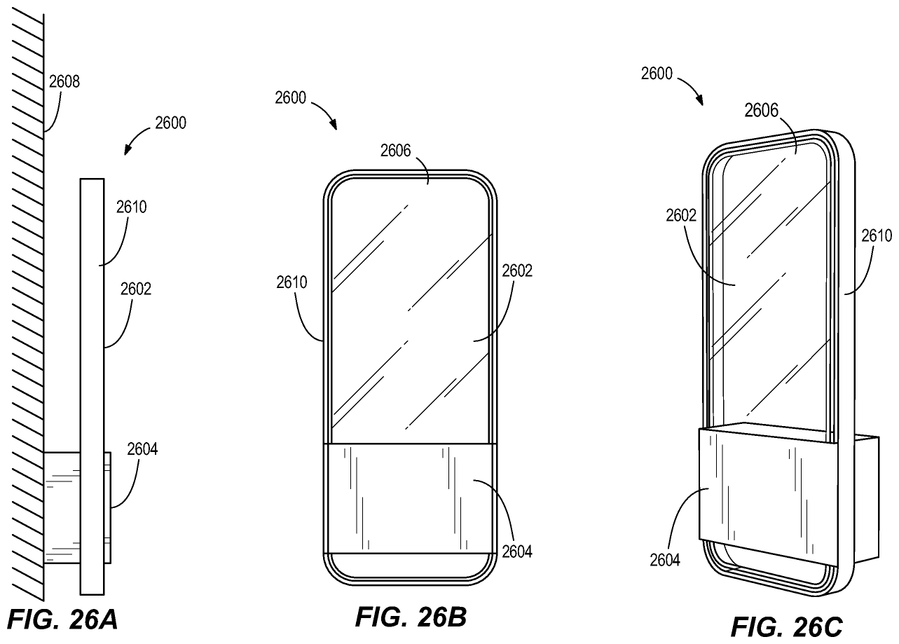

Referring now to FIGS. 26A-26C, a user control device 2600 is shown, according to some embodiments. User control device 2600 is shown to include a touch-sensitive display 2602 mounted within a frame 2610 and a housing 2604 connecting display 2602 to wall 2608. Display 2602 may be the same or similar to transparent display 970 as previously described. Housing 2604 may be similar to housing 972 as previously described. For example, housing 2604 may house a variety of sensors and/or electronic components. In some embodiments, housing 2604 includes a rear portion that extends between display 2602 and wall 2608 and a front portion that extends in front of display 2602. In some embodiments, frame 2610 extends from wall 2608 at least as far as display 2602 such that display 2602 is not visible from the side (as shown in FIG. 26A). In some embodiments, user control device 2600 includes an ambient lighting frame 2606 around display 2602.

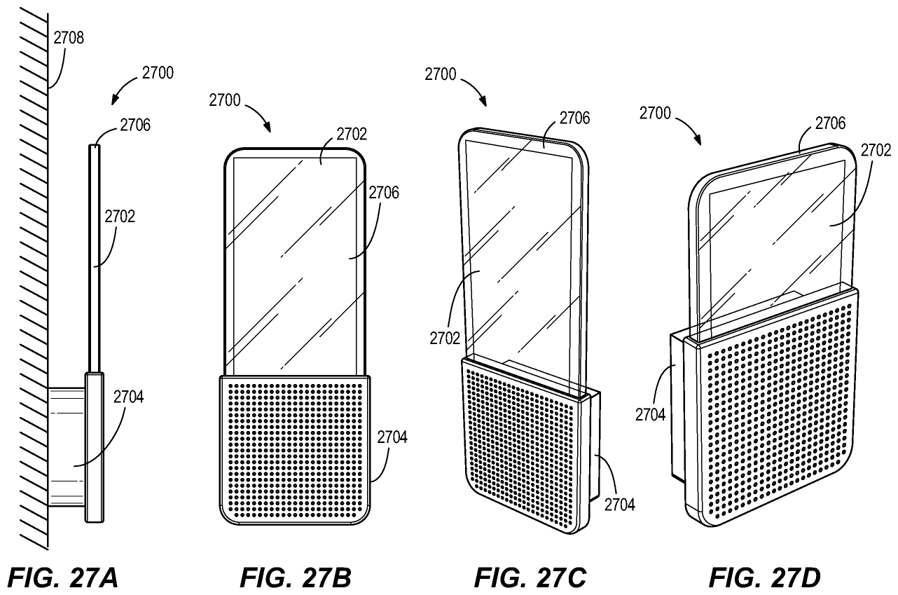

Referring now to FIGS. 27A-27D, a user control device 2700 is shown, according to some embodiments. User control device 2700 is shown to include a touch-sensitive display 2702, a housing 2704, and an ambient lighting frame 2706 around display 2702. Display 2702 may be the same or similar to transparent display 970 as previously described. Display 2702 may have any size or aspect ratio as shown in FIGS. 27C-27D. In some embodiments, housing 2704 is attached to an end (e.g., a lower surface) of display 2702 and connects display 2702 to wall 2708. Housing 2704 may be similar to housing 972 as previously described. In some embodiments, housing 2704 is recessed or partially-recessed into wall 2708. In other embodiments, housing 2704 is completely external to wall 2708.

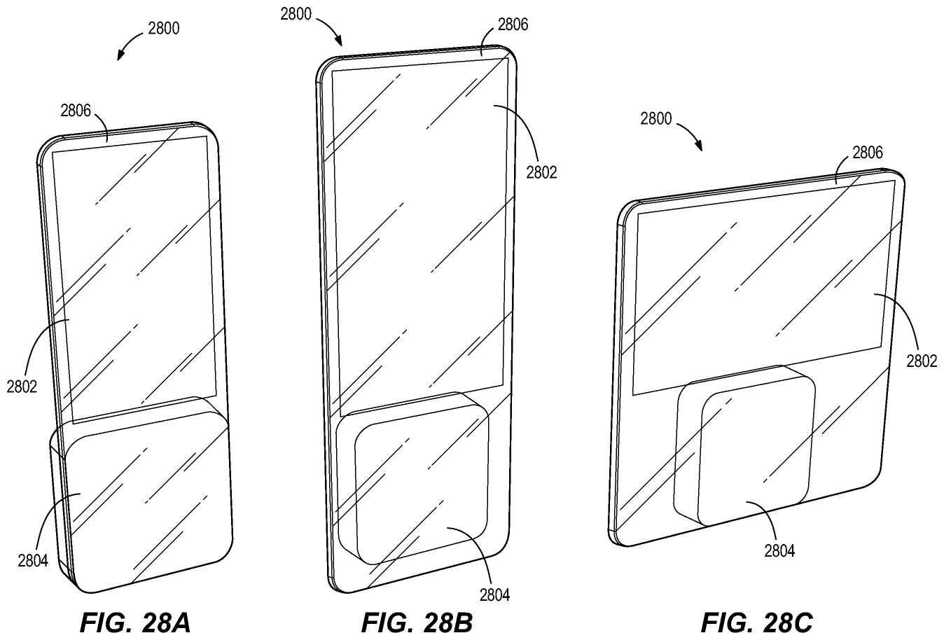

Referring now to FIGS. 28A-28C, a user control device 2800 is shown, according to some embodiments. User control device 2800 is shown to include a touch-sensitive display 2802, a housing 2804, and an ambient lighting frame 2806 around display 2802. Display 2802 may be the same or similar to transparent display 970 as previously described. Display 2802 may have any size or aspect ratio as shown in FIGS. 28A-28C. In some embodiments, housing 2804 is attached to an end (e.g., a lower surface) of display 2802 and connects display 2802 to a wall on which user control device 2800 is mounted. In some embodiments, housing is positioned between the front surface of display 2802 and the mounting wall such that housing 2804 is completely hidden behind display 2802. Housing 2804 may be similar to housing 972 as previously described. In some embodiments, housing 2804 is recessed or partially-recessed into the wall or mounting surface. In other embodiments, housing 2804 is completely external to the wall or mounting surface.

### Control Device Functionality

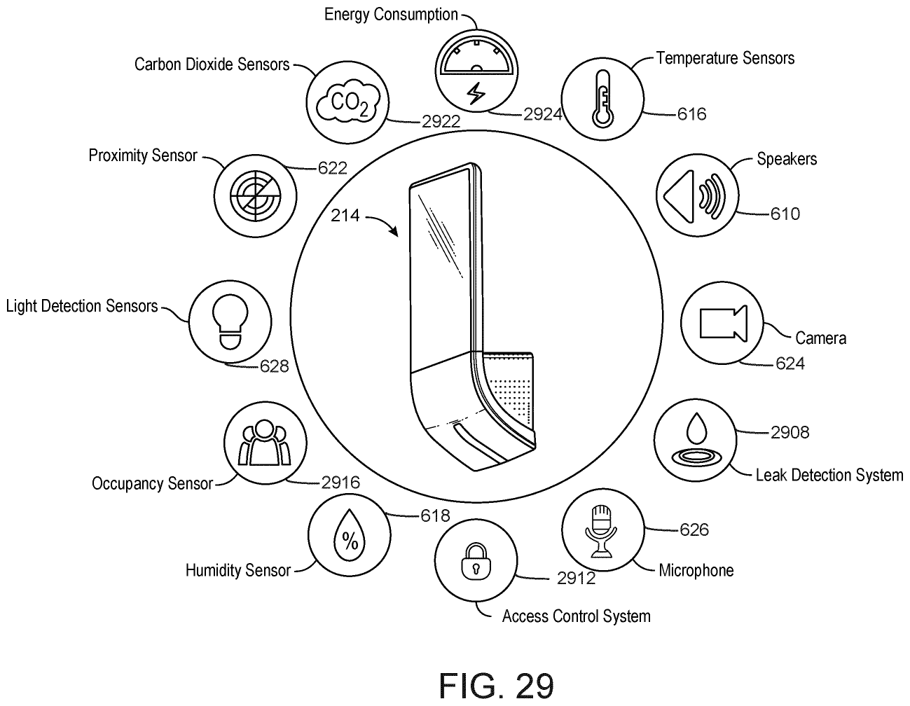

Referring now to FIG. 29, control device 214 is shown as a connected smart hub or private area network (PAN), according to some embodiments. Control device 214 may include a variety of sensors and may be configured to communicate with a variety of external systems or devices. For example, control device 214 may include temperature sensors 616, speakers 610, leak detection system 2908, microphone 626, humidity sensor 618, access control system 2912, occupancy sensors 2916, light detection sensors 628, proximity sensor 622, carbon dioxide sensors 2922, or any of a variety of other sensors. Alternatively, control device 214 may receive input from external sensors configured to measure such variables. The external sensors may not communicate over a PAN network but may communicate with control device 214 via an IP based network and/or the Internet.

In some embodiments, speakers 610 are located locally as a component of control device 214. Speakers 610 may be low power speakers used for playing audio to the immediate occupant of control device 214 and/or occupants of the zone in which control device 214 is located. In some embodiments, speakers 610 may be remote speakers connected to control device 214 via a network. In some embodiments, speakers 610 are a building audio system, an emergency alert system, and/or alarm system configured to broadcast building wide and/or zone messages or alarms.

Control device 214 may communicate with camera 624, an access control system 2912, a leak detection system 2908, an HVAC system, or any of a variety of other external systems or devices which may be used in a home automation system or a building automation system. Control device 214 may provide a variety of monitoring and control interfaces to allow a user to control all of the systems and devices connected to control device 214. Exemplary user interfaces and features of control device 214 are described in greater detail below.

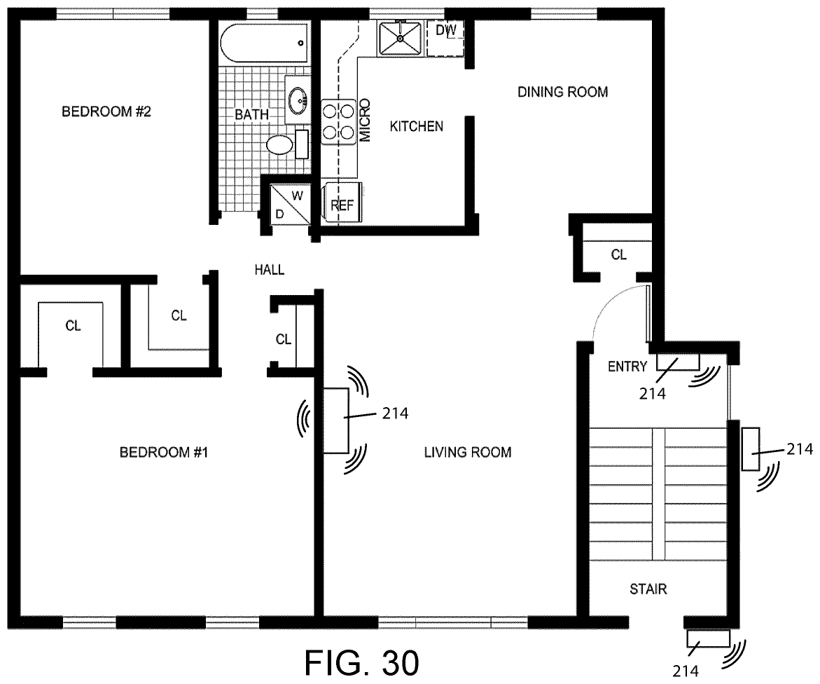

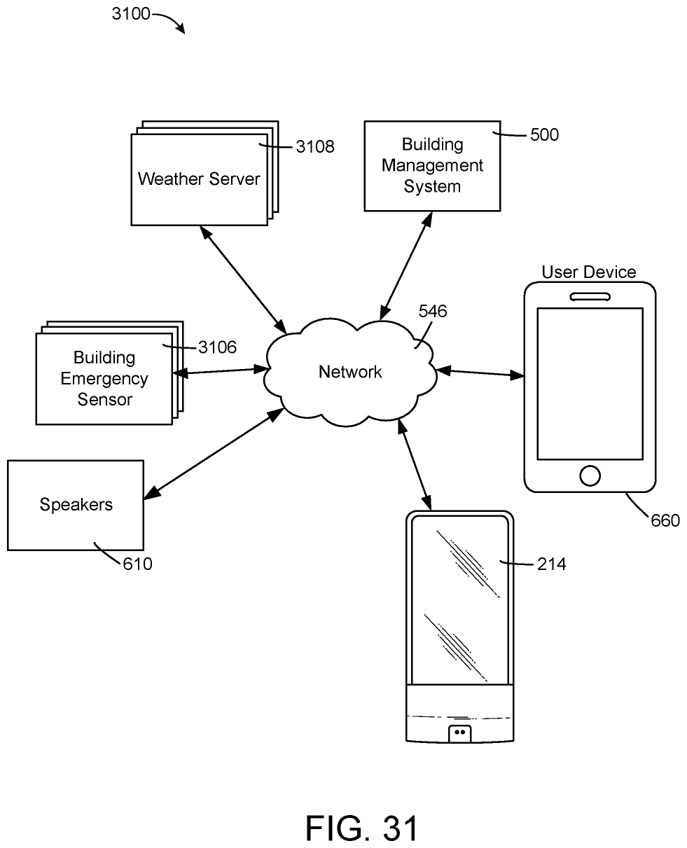

Referring now to FIG. 30, a floorplan of a home is shown. The home is shown to include several different entrance doors. An interior control device 214 may be installed in one of the rooms. For example, FIG. 30 shows a control device 214 installed in the living room. The interior control device 214 may serve as a central hub for monitoring occupancy and access to the home.

Control devices may be installed at various entrance points outside of (or within) the home. For example, FIG. 30 shows a control device 214 installed at each of the exterior doors. The control devices may be configured to receive user inputs (e.g., voice commands via a microphone, video, biometric inputs, access codes, etc.). The control devices may further be configured to provide outputs to a user (e.g., sound, video). The control devices may communicate (e.g., wirelessly or via a wired communications link) with each other and/or additional devices (e.g., a user device such as a cell phone).

Referring now to FIG. 31, a block diagram of communications system 3100 is shown, according to an exemplary embodiment. System 3100 can be implemented in a building (e.g. building 10) and is shown to include control device 214, network 546, building emergency sensor(s) 3106, weather server(s) 3108, building management system 500, and user device 660. System 3100 connects devices, systems, and servers via network 546 so that building information, HVAC controls, emergency information, security information, access information, and other information can be passed between devices (e.g., control device 214, user device 660, and/or building emergency sensor(s) 3106) and servers and systems (e.g., weather server(s) 3108 and/or building management system 3110). In some embodiments, control device 214 is connected to speakers 610 as described with reference to FIG. 6.

In some embodiments, network 546 communicatively couples the devices, systems, and servers of system 3100. Network 546 is described in greater detail with reference to FIG. 5

In some embodiments, control device 214 is connected to building emergency sensor(s) 3106. In some embodiments, building emergency sensor(s) 3106 are sensors which detect building emergencies. Building emergency sensor(s) 3106 may be smoke detectors, carbon monoxide detectors, carbon dioxide detectors, an emergency button (e.g., emergency pull handles, panic buttons, a manual fire alarm button and/or handle, etc.) and/or any other emergency sensor. In some embodiments, the emergency sensor(s) include actuators. The actuators may be building emergency sirens and/or building audio speaker systems (e.g., speakers 610), automatic door and/or window control, and any other actuator used in a building.

In some embodiments, control device 214 may be communicatively coupled to weather server(s) 3108 via network 546. Control device 214 may be configured to receive emergency weather alerts (e.g., flood warnings, fire warnings, thunder storm warnings, winter storm warnings, etc.) In some embodiments, control device 214 may be configured to display emergency warnings via a user interface of control device 214 when control device 214 receives an emergency weather alert from weather server(s) 3108. The control device 214 may be configured to display emergency warnings based on the data received from building emergency sensor(s) 3106. In some embodiments, the control device 214 may cause a siren (e.g., speakers 610 and/or building emergency sensor(s) 3106) to alert occupants of the building of an emergency, cause all doors to become locked and/or unlocked, cause an advisory message be broadcast through the building, and control any other actuator or system necessary for responding to a building emergency.

In some embodiments, control device 214 is configured to communicate with building management system 500 via network 546. Control device 214 may be configured to transmit environmental setpoints (e.g., temperature setpoint, humidity setpoint, etc.) to building management system 500. In some embodiments, building management system 500 may be configured to cause zones of a building (e.g., building 10) to be controlled to the setpoint received from control device 214. In some embodiments, building management system 500 may be configured to control the lighting of a building. In some embodiments, building management system 500 may be configured to transmit emergency information to control device 214. In some embodiments, the emergency information is a notification of a shooter lockdown, a tornado warning, a flood warning, a thunderstorm warning, and/or any other warning. In some embodiments, building management system 500 is connected to various weather servers or other web servers from which building management system 500 receives emergency warning information.

Control device 214 is configured to communicate with user device 660 via network 546. In some embodiments, user device 660 is a smartphone, a tablet, a laptop computer, and/or any other mobile and/or stationary computing device. Control device 214 may be configured to display building map direction to a user associated with user device 660 and/or any other information. In some embodiments, control device 214 and/or user device 660 may communicate with a building's “smart locks.” Accordingly, control device 214 and/or user device 660 may be configured to control smart locks (e.g., control device 214 may lock or unlock a door via a smart lock).

In some embodiments, a user may press a button on a user interface of control device 214 indicating a building emergency. The user may be able to indicate the type of emergency (e.g., fire, flood, active shooter, etc.) Control device 214 may communicate an alert to building management system 500, user device 660, and any other device, system, and/or server.

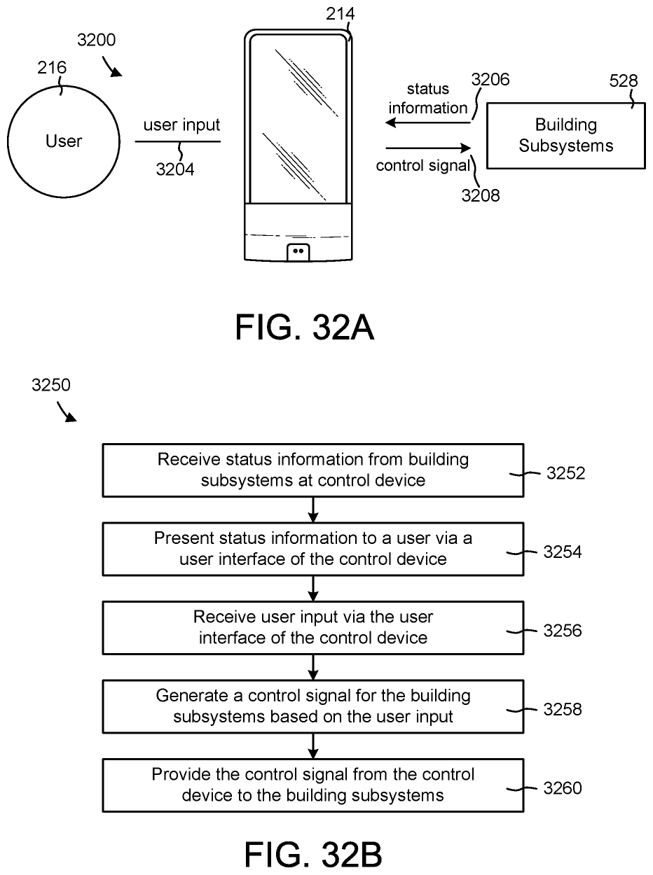

Referring now to FIGS. 32A-32B, a flow diagram 3200 and flowchart 3250 illustrating a control process which may be performed by control device 214 are shown, according to some embodiments. Control device 214 is shown receiving status information 3206 from building subsystems (step 3252). Control device 214 may present status information 3206 to a user 216 via a local user interface (step 3254). Control device 214 may receive user input 3204 via the local user interface (step 3256). Control device 214 may use the user input 3204 in combination with status information 3206 to generate a control signal 3208 for building subsystems 528 (step 3258). Control device 214 may then provide the control signal 3208 to building subsystems 528 (step 3260).

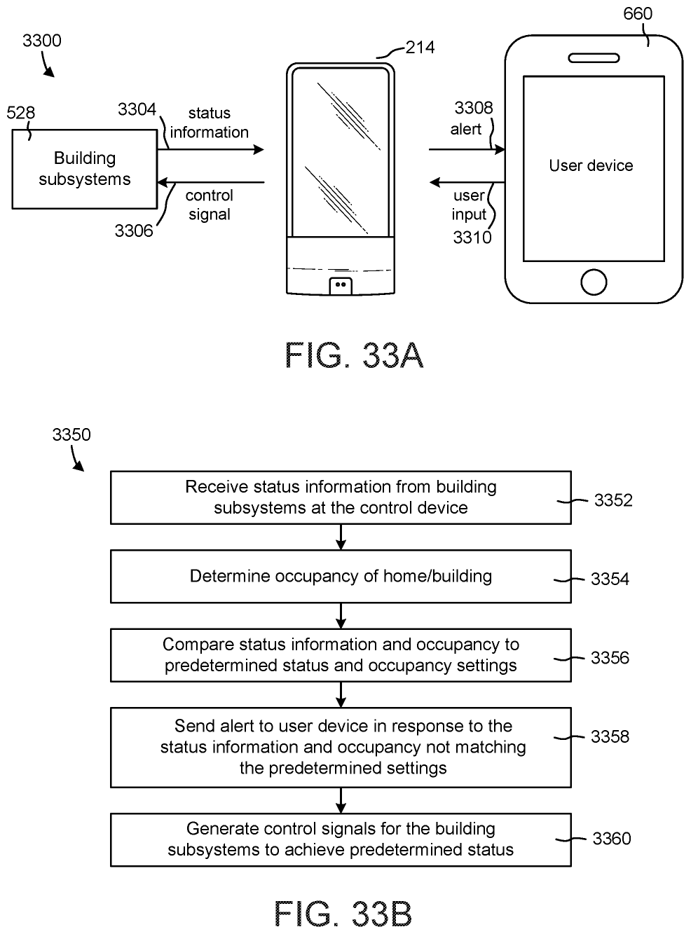

Referring now to FIGS. 33A-33B, a flow diagram 3300 and flowchart 3350 illustrating a control process which may be performed by control device 214 are shown, according to some embodiments. Control device 214 may receive status information 3304 from building subsystems 528 (step 3352) and determine an occupancy of the home/building (step 3354). The status information 3304 may include the status of building subsystems 528 (e.g., blinds closed, lights off, doors locked, etc.). The occupancy of the home/building may be determined based on input from an occupancy sensor.

Control device 214 may compare status information 3304 and occupancy to predetermined status and occupancy settings (step 3356). In some embodiments, the predetermined status and occupancy settings are stored in a memory of control device 214 and may indicate desired status and occupancy settings at a predetermined time (e.g., an end of the day). Control device 214 may determine whether the actual status information 3304 and the occupancy of the home/building match the predetermined settings and may send an alert 3308 to user device 660 in response to the status information 3304 and/or occupancy not matching the predetermined settings (step 3358). In some embodiments, control device 214 generates control signals 3306 for the building subsystems 528 to achieve the predetermined status (step 3360). The control signals may be generated automatically by control device 214 or in response to a user input 3310 received from user device 660.

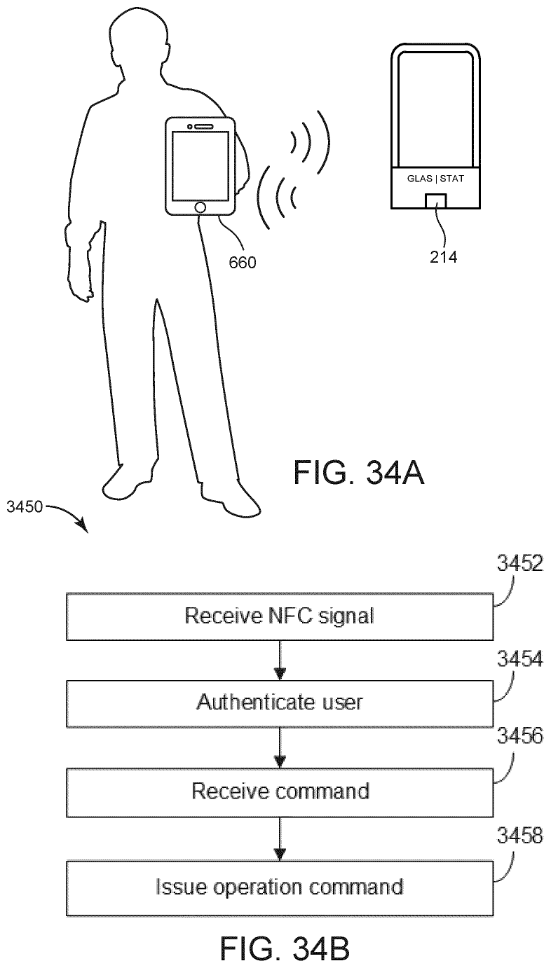

Referring now to FIGS. 34A and 34B, control device 214 may be able to base control and operation decisions on data obtained through near field communication (NFC). In one embodiment, a user brings user device 660 within range of an NFC transmitter integrated with control device 214, as shown in FIG. 34A. This may be referred to as “checking in.” FIG. 34B describes process 3450, an exemplary embodiment of the method. In step 3452, control device 214 may receive identifying information through NFC. This information may include preferred settings for control device 214 and payments, for example. Upon authentication and identification of the user through user device 660, control device 214 is receptive to commands (step 3454).

In some embodiments, control device 214 may provide an audible indication that the scan has occurred. For example, control device 214 may beep to let users know that scanning has been completed. In other embodiments, control device 214 may provide visual feedback that scanning has occurred. For example, control device 214 may flash a corresponding display and/or ambient lighting. In another embodiment, control device 214 may communicate to user device 214 to provide an indication, such as beeping, flashing, or vibrating, that scanning has occurred. Control device 214 may alert the user that scanning has occurred in any number of ways not limited to those enumerated. Upon receiving a command in step 3456, control device 214 then transmits the command to connected equipment (step 3458).

In some embodiments, control device 214 may detect that no users have been associated, and may display a prompt on the corresponding display or on user device 660 with a tutorial on how to set up user device 660. For example, if control device 214 has just been installed and has no associated users and detects Jill's phone, control device 214 may display a message on Jill's phone asking whether she would like a tutorial of how to set up control device 214, or if she would like a walkthrough of any of the features of control device 214.

In multiple occupancy buildings/homes, control device 214 may allow multiple users. In some embodiments, a user may designate themselves as the master user, and may be able to override all commands to control device 214 from other users. In some embodiments, a new master user may be designated through an NFC check in based on the identifying information received by control device 214. For example, master user Jill may leave for work early in the morning while Jack remains at home until the afternoon. Jack may be able to check in and become the new master.

In some embodiments, control device 214 may automatically execute commands communicated through NFC. Users may be able to queue commands to control device 214 on their electronic device and transmit them through the use of NFC. In some embodiments, an application made by Johnson Controls Inc. for interacting with control device 214 may be available for download to a user's device. In some embodiments, if a user has not downloaded the application, control device 214 may be able to detect this and activate a prompt which asks the user if they would like to install the application. Control device 214 may be able to communicate with network 546 and initiate the installation process for the application. In other embodiments, a web-based application may be available for use with control device 214. For example, Johnson Controls Inc. may create an application which users can access from any device with network connectivity.

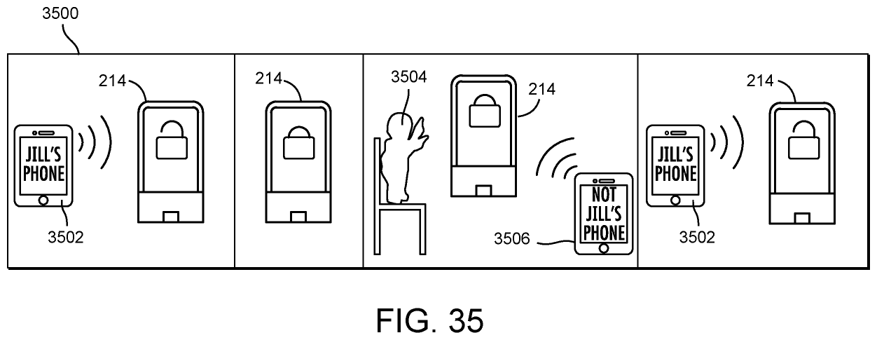

Referring now to FIG. 35, the process of locking control device 214 over NFC is shown. A user (in this exemplary process, Jill) may check in with control device 214 with device 3502 and send the command to lock operation. Control device 214 receives the command and locks operation until another command is received. All attempts to input commands from other users (device 3506), pets, or small children (baby 3504) will be denied. Upon check in from the same user's device, cellphone 3502, which locked control device 214, and receiving the unlock command, control device 214 may resume operation and become receptive to commands from other users.

In some embodiments, control device 214 may be commanded to allow other authorized users who check in to unlock operation. For example, Jill could send a command authorizing Jack to unlock operation—no one but Jack and Jill can unlock control device 214. In other embodiments, a user may be able to lock control device 214, but a master user may be able to unlock control device 214 without specifically being authorized to do so. For example, Jack may lock control device 214 without designating anyone else as an authorized user; because Jill is a master user, Jill can unlock control device 214. In some embodiments, a user may have more than one device associated with him and control device 214 may recognize all devices and allow him to lock and unlock devices with different devices associated with him.

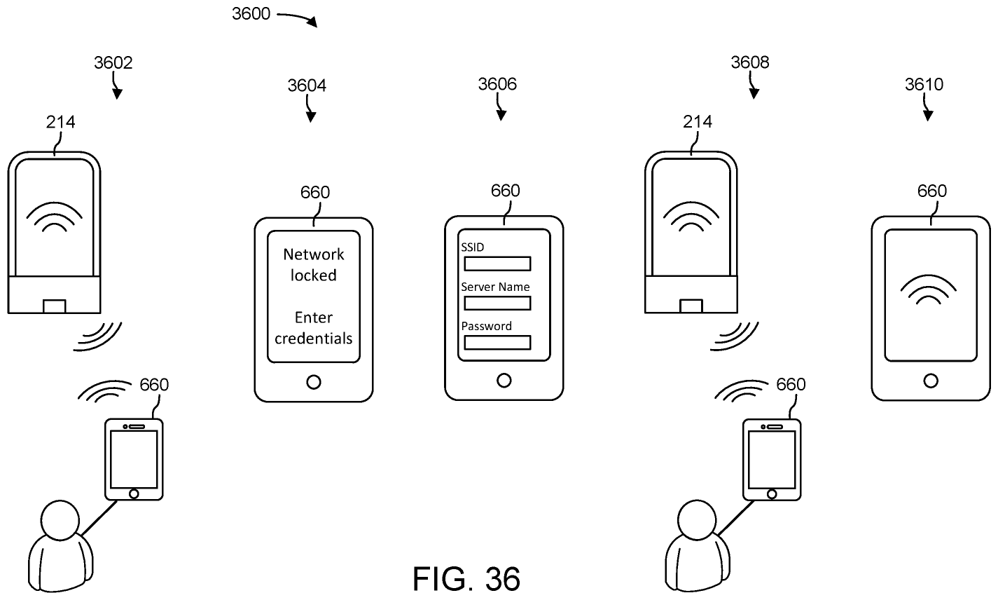

Referring now to FIG. 36, a process 3600 in which a user is authenticated to access a network through control device 214 is shown, according to some embodiments. Process 3600 begins with step 3602. In step 3602, a user is shown to have user device 660, and attempts to access a network (e.g., network 546). User device 660 may be a mobile device. In some embodiments, user device 660 is a smartphone. In other embodiments, user device 660 is any mobile device, such as a laptop computer, smart watch, etc. User device 660 is shown to be communicating with control device 214.

In some embodiments, user device 660 communicates with control device 214 via a communications interface specific to user device 660 and control device 214. In other embodiments, user device 660 communicates with control device 214 via a standard communications interface (e.g., WiFi, Bluetooth, etc). User device 660 may communicate with control device 214 via any communications interface, and is not limited to those specifically enumerated herein.

Control device 214 may act as a router, modem, etc. to at least partially facilitate access to network 546. In some embodiments, control device 214 requires authentication of a user prior to granting access to network 546. For example, control device 214 may require a password, digital certificate, etc. In other embodiments, control device 214 may require different levels of authentication for different networks, different user types, etc., or may not require authentication of a user.

Process 3600 continues with step 3604, in which a user is informed that network 546 is locked, and requires the user to be authenticated. In this exemplary embodiment, the user must enter credentials. In other embodiments, network 546 may automatically detect credentials of and/or authenticate the user. For example, network 546 may detect a digital certificate on user device 660 authenticating the user. In this exemplary embodiment, the user is provided information through user device 660. In other embodiments, the user may be provided information through any medium, such as a corresponding user interface.

Process 3600 continues with step 3606, in which a user is prompted to provide credentials to access network 546. In this exemplary embodiment, the user is provided information through user device 660. In other embodiments, the user may be provided information through any medium, such as a corresponding user interface. In some embodiments, credentials may be a user name and password. In other embodiment, credentials may be an SSID of network 546, a server name, etc. Credentials requested to authenticate the user may be any credentials, and are not limited to those specifically enumerated.

Process 3600 continues with step 3608, in which the user has provided credentials, which are communicated to control device 214. In some embodiments, the user provides credentials through user device 660. In other embodiments, the user may provide credentials in any way, such as voice commands, tactile input to a corresponding user interface, etc. For example, a user may say his password, and the password may be directly received by control device 214. In another example, a user may say his password to user device 660, which may process the input and transmit a control signal to control device 214.

In some embodiments, the credentials are incorrect, or otherwise fail to grant the user access to network 546. Control device 214 may allow the user to try again. In some embodiments, the user is given a certain number of attempts to access network 546 before being banned, forced to wait a certain period of time, use a secondary form of authentication, etc. In other embodiments, the user is given unlimited attempts to access network 546.

Process 3600 continues with step 3610, in which the user gains access to network 546. In some embodiments, access to network 546 is granted to user device 660. For example, if a user attempts to access network 546 through user device 660, if access is granted, access is granted to user device 660. In other embodiments, access to network 546 is granted to a device with which a user provides credentials. For example, if a user initiates the authorization process through his laptop, but provides credentials with his smart phone, he may only be granted access to network 546 through his smart phone. In yet other embodiments, access to network 546 is granted to a device specified by the user, all devices within operating range, etc. Process 3600 may be performed by control device 214.

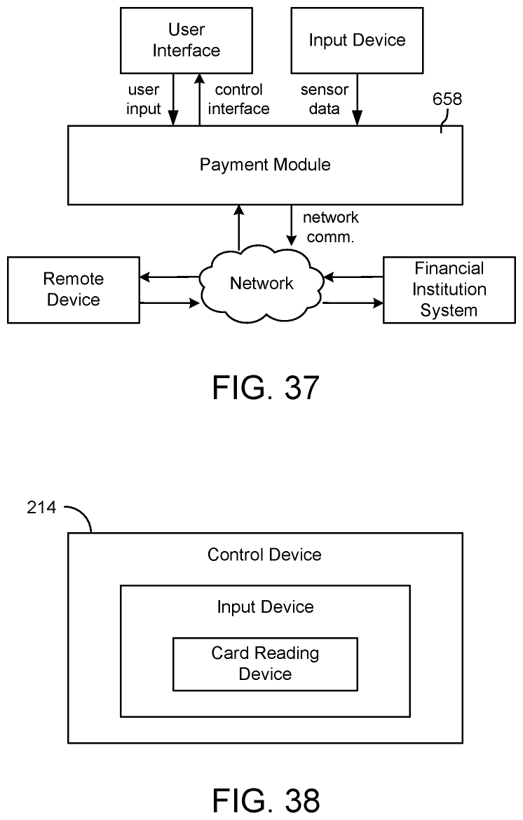

Referring to FIGS. 37-41, in some embodiments, control device 214 may include payment features allowing a user to make payments with a variety of different devices using a variety of different payment protocols. For example, control device 214 may be installed in any location in which a user may make a payment directly, without the involvement of a cashier or other worker, such as in a vehicle (e.g., a taxi), a parking structure, a public transportation station, a hotel, or a retail location (e.g., a store checkout line, a trade show, a convention, etc.).

Referring now to FIG. 37, payment module 658 is shown in detail. Payment module 658 is a module of memory 642 that facilitates payment functions of control device 214. Payment module 658 is shown to interact with a user interface, an input device, a financial institution system, and a network. The user interface may be an embodiment of user interface 602. For example, the user interface may function in any capacity described above with respect to user interface 602. The network may be an embodiment of network 546. For example, the network may function in any capacity described above with respect to network 546.

In some embodiments, payment module 658 may interact with a remote device. The remote device may be any device providing data related to a financial transaction. For example, the remote device may be a cash register or terminal, a taximeter, a mobile device, or any other device capable of providing data related to a financial transaction. The remote device may be directly coupled to control device 214 and directly communicates with the control device 214 with a wired or wireless connection. In some embodiments, the remote device is coupled to the control device 214 through a network and communicates with the control device 214 through the network.

Referring now to FIG. 38, the input device of control device 214 is shown to include a card reading device according to one exemplary embodiment. The card reading device may be any device that is able to receive information from a card (e.g., credit card, debit card, gift card, commuter card, etc.). Referring to FIG. 38, in one embodiment, the card reading device may be a magnetic strip reader that is configured to receive information encoded in a magnetic strip on the card. Information encoded on a magnetic strip of the user's card may be read by the card reading device by inserting the card into the card reading device or by swiping the card through the card reading device. In another embodiment, the card reading device may be a chip reader that is configured to receive information encoded on a microchip on the card. Information encoded on the microchip of the user's card may be read by the card reading device by inserting the card into the card reading device. In another embodiment, the card reading device may use another technology to receive information encoded on the user's card. For example, the card reading device may include an infrared scanning mechanism to read information encoded in a bar code on the user's card.

In some embodiments, the input device (e.g., card reader, wireless reader, etc.) may be integrated into control device 214. For example, the input device may be integrally formed with the display or the base. In other embodiments, the input device may be coupled to the display or the base (e.g., as an aftermarket device, etc.). In other embodiments, the input device may be separate from the control device 214 and may be connected to the control device 214 through a wired connection or a wireless connection.

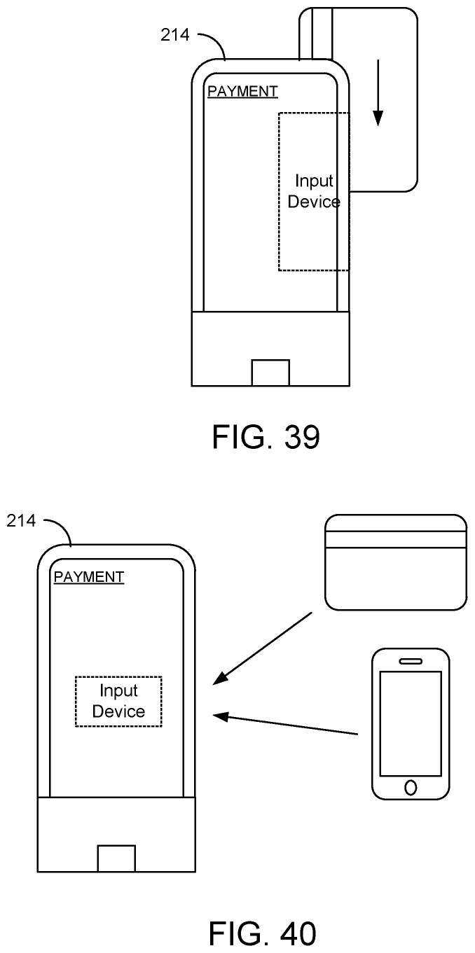

Referring now to FIGS. 39 and 40, control device 214 is shown to include an input device that is able to receive information from a card (e.g., credit card, debit card, gift card, commuter card, etc.) or mobile device without physically interacting with the card or mobile device using a wireless protocol (e.g., ZigBee, Bluetooth, WiFi, NFC, RFID, etc.). In one exemplary embodiment, a user may make a payment by passing a device capable of NFC communication in close proximity to the user control device to make a payment using a mobile payment service (e.g., Apple Pay, Google Wallet, Android Pay, etc.).

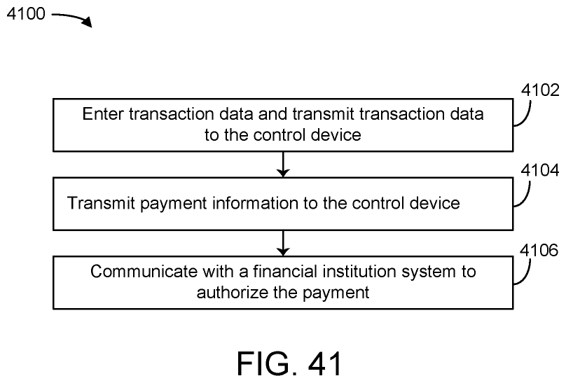

Referring now to FIG. 41, a process 4100 for making a payment with control device 214 is shown according to some embodiments. Process 4100 begins with step 4102 in which transaction data is entered and the transaction data is communicated to control device 214. In some embodiments, the transaction data may be entered directly into control device 214 with the user interface. In some embodiments, the transaction data is received from a remote device. For example, transaction data may be received from a cash register, a payment terminal, a taximeter, a mobile device, etc.

The process continues with step 4104 in which payment data is received by control device 214. Payment data may be received, for example, by swiping a card through a card reader, inserting a card into a card reader, passing a card under a sensor (e.g., an infrared sensor), or holding a card or mobile device close to control device 214. The payment data may include various information such as authentication data, encryption data, decryption data, etc.

The process continues with step 4106 in which control device 214 communicates with a financial institution system to authorize the payment. The financial institution system may, for example, be a credit card company or a banking network. The control device 214 communicates a variety of information to the financial institution data including payment data and transaction data to authorize the payment.

### Access Control

As described above with respect to various embodiments, a control device (e.g., control device 214) may be used to grant and deny access to various areas. For example, control device 214 may be placed outside of a house, and users may interact with control device 214 to unlock the door to the house. As another example, control device 214 may be placed at the entrance to a parking garage, and a user may pay via control device 214 prior to having garage access.

In some embodiments, control device 214 may be user-customizable. For example, a user at a high-security office building may customize control device 214 to implement extensive user identification processes (e.g., biometric inputs, voice recognition, facial recognition). In contrast, for example, a homeowner may customize control device 214 to grant access to a user who simply inputs a correct PIN. As a further example, a hotel owner may customize control device 214 to respond to an RFID chip or a known user device (e.g., a smartphone) when a user attempts to unlock the door to their hotel room.

It may be appreciated that the transparent and low profile nature of control device 214 may reduce an individual's awareness of security, and may lessen the intimidation of high-security areas. Similarly, unauthorized users may be deterred from attempting to gain access to secure areas. For example, an individual attempting to break in to a locked building may intuitively search for a keypad or physical lock, but control device 214 may be overlooked due to its transparent nature.

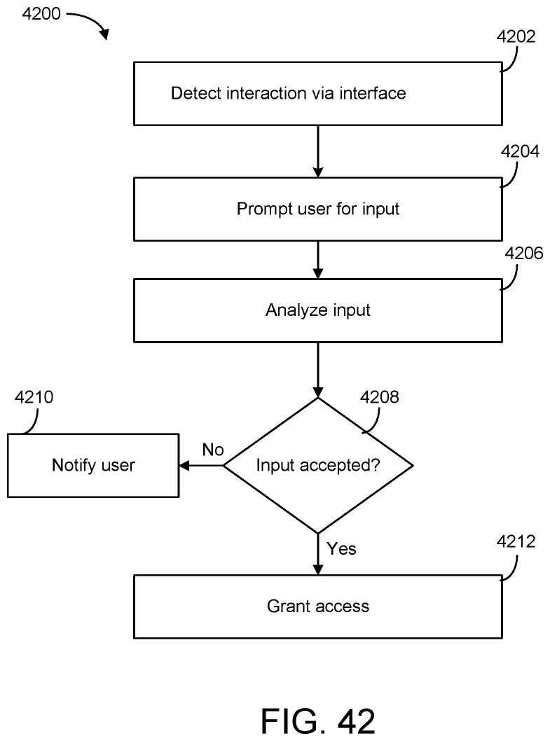

Various access control methods are described with respect to FIGS. 42-47. The methods shown in FIGS. 42-47 may be carried out via control device 214. Alternatively, the methods may be carried out by a different type of controller.

Referring now to FIG. 42, a flowchart of a method 4200 for controlling access is shown, according to some embodiments. Method 4200 is shown to include detecting interaction via an interface (step 4202). In some embodiments, the interface may be a user interface corresponding to control device 214 (e.g., user interface devices 602). In some embodiments, the interface may be positioned remotely to control device 214, but may be in wireless or wired communication with control device 214.

In some embodiments, the detection of interaction may include determining a user touch via the interface. The detection may also occur via a physical button located on the interface. In some embodiments, the detection may include sensing an RFID chip and/or an NFC chip within a certain proximity of the interface and/or control device 214. In some embodiments, the detection may include sensing a card swipe via a card reader corresponding to control device 214. In some embodiments, the detection may include voice recognition and/or motion detection. In some embodiments, the detection may include communication from a remote device, such as a user device. Additional methods of detection may be implemented.

Still referring to FIG. 42, method 4200 is shown to include prompting a user for input (step 4204). In some embodiments, prompting may be done via audio and/or visual. For example, in some embodiments, control device 214 may output a tone and/or recording via speakers 610. In some embodiments, control device 214 may communicate with a user device (e.g., user device 660), and the user device may output a tone and/or recording. Further, in some embodiments, control device 214 may display a prompt to the user. In some embodiments, the display may include flashing light, the appearance of a keypad, the indication of a sensor (e.g., a biometric input sensor), and/or video communication with a remote user (e.g., a security officer). In some embodiments, a user may be prompted via a known user device (e.g., user device 660). In some situations, it may be beneficial to provide written prompts via user interface 602. Additional methods of prompting a user may be implemented. In some embodiments, method 4200 may be performed without prompting a user for input. For example, if control device 214 detects and reads an RFID chip, additional user input may not be requested, and method 4200 may proceed to step 4206.

Method 4200 is shown to further include analyzing an input (step 4206). Upon receiving a user input, control device 214 may process the input to determine if access should be granted. For example, if a user inputs an incorrect PIN, control device 214 may be configured to deny access to the user. Conversely, if control device 214 determines that the PIN is correct, the user may be granted access. In some embodiments, the step of analyzing an input may include communicating with other devices via a network (e.g., network 546). Particularly, in some situations, control device 214 may communicate over a network to determine the identity of a user (e.g., via a database).

User inputs may include, but are not limited to, voice, video or image capture, biometric inputs (e.g., finger and/or retina scanning), passwords (e.g., PIN, pattern, word/phrase entry), touch inputs via a user interface (e.g., user interface 602), payment, and commands sent via a user device (e.g., user device 660).

Still referring to FIG. 42, method 4200 is shown to include determining if the input is accepted (step 4208). If the input is not accepted (i.e., the result of step 4208 is “no”), the user is notified (step 4210). Conversely, if the input is accepted (i.e., the result of step 4208 is “yes”), then access is granted (step 4212). In some embodiments, the determination of whether or not to accept the input includes comparing the user input to known user inputs. In some situations, the known user inputs may be stored in a memory corresponding to control device 214 (e.g., memory 642, a remote memory connected to network 546, etc.). In some situations, it may be beneficial to compare the user input to previously entered user inputs (e.g., previous voice commands from users), to determine whether to accept the user input. Over time, for example, control device 214 may “learn” user behavior and trends.

In some embodiments, notifying a user (step 4210) may include notifying an authorized user (e.g., via a remote user device, via network 546, etc.). In some situations, the authorized user may be a homeowner, a security officer, a building manager, or other known user. Notifying an authorized user when a user input is not accepted may alert the authorized user to, for example, the presence of an intruder. In some embodiments, an authorized user may receive a phone call, a text message, an email, and/or an alert on a user device (e.g., a smartphone, smartwatch, etc.). In some situations, control device 214 may contact an authorized user only after a threshold number of input attempts has been exceeded. For example, an authorized user may be contacted after three rejections of a user input. The threshold number of input attempts may be time-bound (e.g., three rejections of a user input within 10 minutes).

In some embodiments, notifying a user (step 4210) may include notifying a user via control device 214. This may include, for example, sounds, lights, visuals on a display, and/or vibrations. In some situations, a color may flash (e.g., electronic display 606 and/or ambient lighting 608 may flash red). Control device 214 may provide guidance to the user, such as a phone number to call for assistance. In some embodiments, control device 214 may prompt a user to provide an additional input upon the first user input being rejected. In some situations, control device 214 may allow multiple attempts (e.g., a user may be allowed to input a PIN repeatedly). Control device 214 may prevent a user from exceeding a threshold number of attempts. For example, if a user inputs three incorrect PINs, control device 214 may prevent the user from attempting a fourth PIN. The threshold number of input attempts may be time-bound.

In some embodiments, control device 214 may prompt a user to provide a different type of input if the first input is rejected. For example, if a user first provides a vocal input to control device 214, and the vocal input is rejected, control device 214 may prompt a user to enter a PIN or use an NFC-enabled device that is registered to an authorized user.

In some embodiments, control device 214 may track user inputs. For example, control device 214 may timestamp each user input, and maintain a log in memory (e.g., memory 642) of each input attempt and outcome (e.g., acceptance or rejection of the user input). In some embodiments, the log may be provided to an authorized user via a network (e.g., network 546).

In situations where the input is accepted (i.e., the result of step 4208 is “yes”), method 4200 is shown to include granting access (step 4212). In some embodiments, granting access may correspond to physical access. For example, a door may unlock, a garage door may open, a turnstile may allow for rotation, an arm in a parking garage may rotate, etc. In some embodiments, granting access may correspond to additional access on control device 214. For example, access may be granted to allow the user to change building subsystem parameters through a user interface of control device 214 (e.g., user interface 602).

In some embodiments, a user may be notified via control device 214 that the input was accepted. This may include, for example, sounds, lights, visuals on a display, and/or vibrations. In some situations, a color may flash (e.g., electronic display 606 and/or ambient lighting 608 may flash green). In some embodiments, control device 214 may utilize the user input to determine a corresponding user identification. For example, each known user may have a corresponding PIN, fingerprint, retina, voice tone and/or pattern, physical features, and/or user device associated with them. Control device 214 may identify a user via the user input, and may look up the identification using a database. In some embodiments, for example, control device 214 may match an input PIN with “user 12.” Control device 214 may then retrieve a stored image of “user 12,” and display the image (e.g., via electronic display 606). In some situations, for example, displaying a user's photo on control device 214 may allow for other users in the immediate area to visually confirm the user's identity. In some embodiments, the image may be displayed on a remote display (e.g., a desktop computer belonging to a security officer).

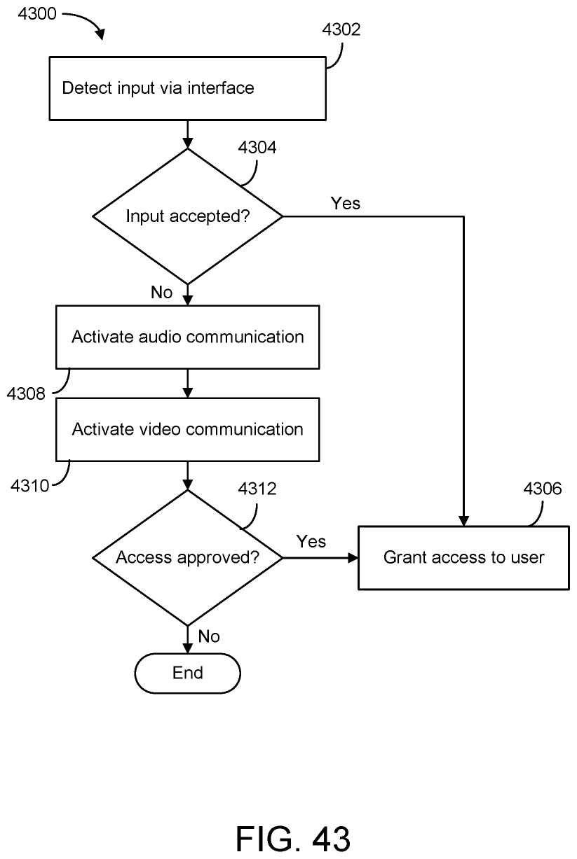

Referring now to FIG. 43, a flowchart of a method 4300 for controlling access is shown, according to some embodiments. Method 4300 is shown to include detecting an input via an interface (step 4302). As described above with respect to FIG. 42, the interface may be a user interface corresponding to control device 214 (e.g., user interface devices 602). In some embodiments, the interface may be positioned remotely to control device 214, but may be in wireless or wired communication with control device 214. Further, detecting the input may include several embodiments.

Once an input is detected, method 4300 is shown to include determining if the input is accepted (step 4304). Determining if the input is accepted may be the same or similar to step 4208 as described with respect to FIG. 42. In situations where the input is accepted (i.e., the result of step 4304 is “yes”), method 4300 is shown to include granting access (step 4212). Granting access to the user may be the same or similar to step 4212 as described with respect to FIG. 42.

In situations where the input is rejected (i.e., the result of step 4303 is “no”), method 4300 is shown to include activating audio communication (step 4308) and activating video communication (step 4310). In some embodiments, audio communication may be activated alone (i.e. without video communication). Similarly, in some embodiments, video communication may be activated alone (i.e. without audio communication). In some situations, it may be beneficial to have audio communication, video communication, or both.

In some embodiments, activating audio communication may include turning “on” microphone 626, which is in communication with control device 214. In some embodiments, activating audio communication may include turning “on” speakers 610, which are also in communication with control device 214. The step of activating audio communication may further include communicating with a remote device (e.g., user device 660, building management system 500, or other device via network 546). The remote device may be associated with a known and authorized user. Further, the communication with the remote device may include activating audio communication within the remote device. In some situations, a request to communicate may be sent to the remote device, and the user may choose to accept or reject the communication request. In some situations, however, it may be beneficial to automatically activate audio communication on the remote device (e.g., a security officer may be actively monitoring control device 214 from a desktop computer during their work shift).

In some embodiments, activating video communication may include turning “on” camera 624, which is in communication with control device 214. In some embodiments, activating video communication may include turning “on” ambient lighting 608, which is also in communication with control device 214. In some situations, such as during low light conditions, it may be beneficial to utilize ambient lighting 608 to clearly capture video of the user.

The step of activating video communication may further include communicating with a remote device (e.g., user device 660, building management system 500, or other device via network 546). The remote device may be associated with a known and authorized user. Further, the communication with the remote device may include activating video communication within the remote device. In some situations, a request to communicate may be sent to the remote device, and the user may choose to accept or reject the communication request. In some situations, however, it may be beneficial to automatically activate video communication on the remote device (e.g., a security officer may be actively monitoring control device 214 from a desktop computer during their work shift).

Once audio and/or video are activated, a user may be able to communicate with an authorized remote user via control device 214. Video and/or audio may be one-way or two-way (e.g., the user may or may not be able to see or hear the authorized user). In situations where two-way communication is implemented, electronic display 606 may function as a video screen for the user. The authorized user may communicate with the user to determine whether or not access should be approved.

If the authorized user determines that the user should be granted access, they may communicate with control device 214 via the remote device. The remote device may send a approval signal to control device 214. Upon receiving an approval signal (i.e., the result of step 4312 is “yes”), control device 214 may then grant access to the user (step 4306). However, upon receiving a denial signal (i.e., the result of step 4312 is “no”), or alternatively, no response has been received from the authorized user, then control device 214 may deny access to the user. Granting access to the user may be the same or similar to step 4212 as described with respect to FIG. 42.

In some embodiments, method 4300 may include the step of displaying contact information on electronic display 606 after an input is rejected. The user may then choose to contact the individual listed using a different device, such as a cellphone. In some embodiments, the user may choose to contact the individual listed by selecting that option via touch-sensitive panel 604. If the option to contact the individual is selected, control device 214 may then proceed with activating audio communication (step 4308) and/or activating video communication (step 4310).

The following examples illustrate applications of method 4300. As a first example, a user may have forgotten their PIN. When the user attempts to enter an incorrect PIN via control device 214, control device 214 may reject the input and activate audio and video communication with a security officer. The security office may ask the user for additional information (e.g., name, department, office number). The user may provide this additional information via control device 214. The security officer may then determine if the user should be given access. If the security office grants access to the user by communicating with control device 214, then control device 214 may grant access to the user (e.g., a door may unlock).

As another example, a user may have forgotten their ID badge that is configured as an accepted input for control device 214. The user may indicate, via touch-sensitive panel 604 or microphone 626 that they need assistance. This indication may activate audio and/or video communication with a building manager, who can determine if the user should be given access. If the building manager decides to deny access to the user, then control device 214 will prevent the user from gaining access (e.g., a door may remain locked).

As previously described, control device 214 may be configured to accept user payment. As another example, a user may attempt to pay via control device 214 when entering/exiting a parking garage. If the payment is rejected, the user may be connected to a garage attendant via audio and video through control device 214. The garage attendant may then approve access for the user, and the garage door may open.

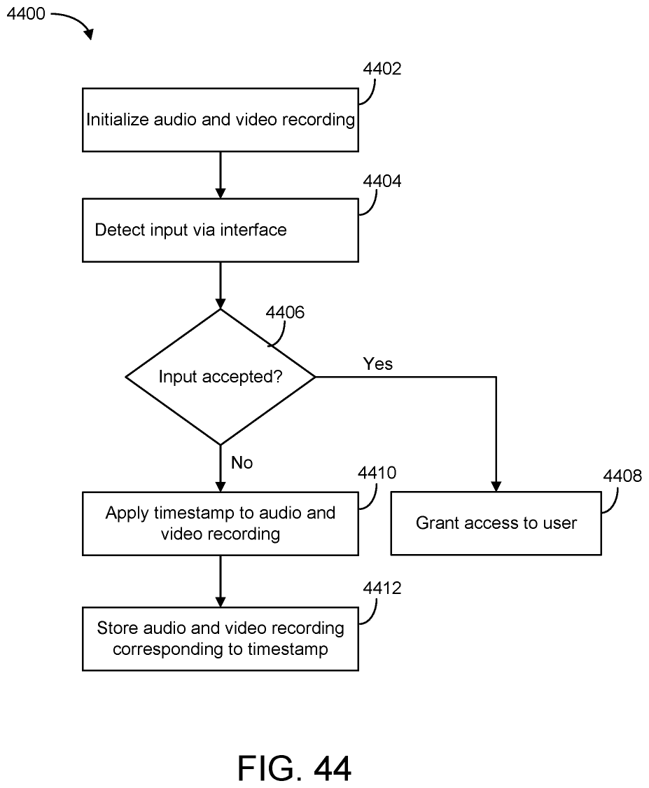

Referring now to FIG. 44, a flowchart of a method 4400 for controlling access is shown, according to some embodiments. Method 4400 is shown to include initializing audio and video recording (step 4402). Initializing audio may include recording via microphone 626, and storing subsequent recordings in transitory or non-transitory memory. Similarly, initializing video may include recording via camera 624, and storing subsequent recordings in transitory or non-transitory memory. In some embodiments, audio and video may be given limited memory, with the memory being deleted and new recordings saved once full. In some situations, recordings may be stored remotely via network 546. For example, recordings may be saved using cloud storage.

In some embodiments, audio and video may not be recorded unless one of sensors 614 senses a change. For example, camera 624 may begin recording if motion is detected. As another example, camera 624 and microphone 626 may begin recording if vibration sensor 630 detects vibration (e.g., if an individual touches control device 214). In some embodiments, audio and video may be continuously recorded, but only stored if a user input to control device 214 is rejected.

Still referring to FIG. 44, method 4400 is shown to include detecting input via an interface (step 4404). This step may be the same or similar to step 4202 as described with respect to FIG. 42. Method 4400 may further include determining if the input is accepted (step 4406). Step 4406 may be the same or similar to steps 4206 and 4208 as described with respect to FIG. 42. If the input is accepted (i.e. the result of step 4406 is “yes”), then the user may be granted access (step 4408). Step 4408 may be the same or similar to step 4212 as described with respect to FIG. 42.

If the input is rejected (i.e. the result of step 4406 is “no”), then a timestamp may be applied to the audio and/or video recording (step 4410). Next, method 4400 is shown to include storing audio and/or video recordings corresponding to the timestamp (step 4412). In some embodiments, step 4412 includes storing the recordings remotely (e.g., using network 546, using user device 660). In some embodiments, a predetermined recording length may be applied to the audio and/or video based on the timestamp. For example, if a user's input is rejected at 5:50 pm, the audio and video recordings may be time stamped at 5:50 pm. Control device 214 may be configured to store a predetermined recording length for situations where a user input is rejected (e.g., ten minutes of recording may be saved—five minutes prior to the timestamp and five minutes after the timestamp). Accordingly, audio and video recordings may be saved from 5:45 pm to 5:55 pm based on the 5:50 pm timestamp. In some embodiments, an authorized user may specify the predetermined recording length. The predetermined recording length may be selected based on the specific use of control device 214.

The timestamped recordings may be viewed by authorized users. Specifically, reviewing audio and/or video may be beneficial after a security breach occurred. For example, a homeowner may arrive home to find that a break-in has occurred. By reviewing stored audio and/or video, the homeowner may determine what time the break-in occurred, and characteristics of the suspect. In some situations, it may be beneficial to have remote cameras in addition to a camera located within control device 214. In some embodiments, audio and/or video recordings relative to a timestamp may be sent to an authorized user (e.g., via user device 660). In this way, an authorized user may be immediately alerted to a potential problem.

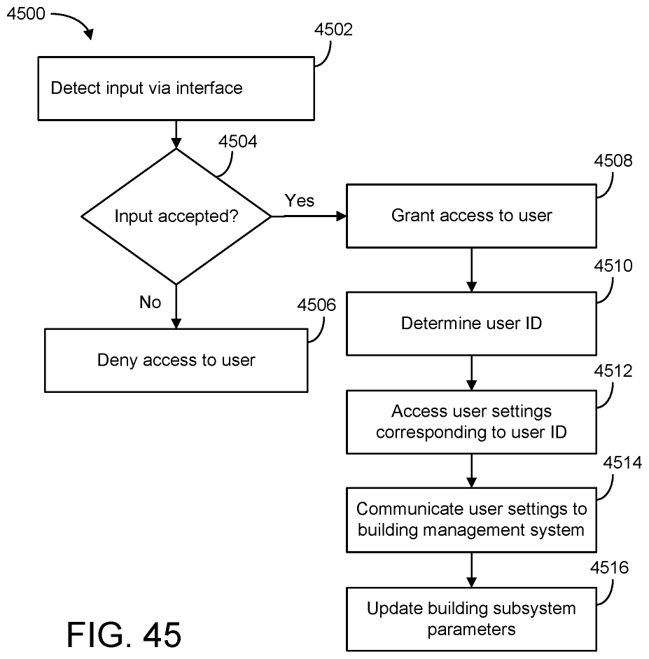

Referring now to FIG. 45, a flowchart of a method 4500 for controlling access is shown, according to some embodiments. Method 4500 is shown to include detecting input via an interface (step 4502). This step may be the same or similar to step 4202 as described with respect to FIG. 42. Method 4500 may further include determining if the input is accepted (step 4504). Step 4504 may be the same or similar to steps 4206 and 4208 as described with respect to FIG. 42. If the input is accepted (i.e. the result of step 4504 is “yes”), then the user may be granted access (step 4508). Step 4508 may be the same or similar to step 4212 as described with respect to FIG. 42. If the input is rejected (i.e., the result of step 4504 is “no”), then the user may be denied access (step 4506).

If a user is granted access (step 4508), method 4500 further includes determining a user ID (step 4510). Determining a user ID may include comparing the user input to known user inputs, where each known user input corresponds to a specific user. For example, each user may have a unique PIN. As another example, each user may have a unique RFID code that can be read by control device 214. Control device 214 may determine the corresponding user ID by referencing a database and/or by communicating with remote devices and/or servers over network 546. User IDs may be stored in a memory corresponding to building management system 500.

Once a user ID has been determined, method 4500 is shown to include accessing user settings corresponding to the user ID. In some embodiments, the user settings may be accessed via a database and/or by communicating with remote devices and/or servers over network 546. In some embodiments, a user profile may be constructed over time, based on user behavior. For example, if a specific user always sets the room temperature to 70 degrees, control device 214 may save a temperature setting of 70 degrees to the specific user's profile.

After determining corresponding user settings (step 4512), method 4500 is shown to include communicating user settings to the building management system (step 4514). In some embodiments, building management system 500 may receive the user settings. The user settings may be communicated over network 546. Method 4500 is shown to further include updating building subsystem parameters (step 4516). In some embodiments, building management system 500 may communicate with building subsystems 528 based on the received user settings. The user settings may be applied to any of building subsystems 528. As one non-limiting example, lighting and temperature may be adjusted based on the received user settings.

In some embodiments, the user settings may include information such as office number, preferred temperature, preferred brightness, among other things. In some situations, the user settings may also include the route that the specific user takes to get from control device 214 to their specific office. In these situations, building management system 500 may communicate with building subsystems 528 to, for example, turn on the lights in each hallway that the specific user will enter.

As one non-limiting example, control device 214 determines that “user 15” has just entered the building using their assigned PIN. Control device 214 proceeds to determine that user 15 works in office XY, which is located next to stairwell B. Control device 214 also determines that user 15 prefers a low light setting and a temperature of 73 degrees. The user settings are then communicated to building management system 500. Building management system 500 then works with building subsystems 528 to implement the user settings. The lights are turned on in stairwell B, and the lights in office XY are set to “low.” The thermostat in office XY is set to 73 degrees.

As another non-limiting example, control device 214 determines that “user 13” has just entered the research facility using their badge. Control device 214 proceeds to determine that the previous day, user 13 had been working with the laboratory heat chamber, and is registered to use it again today. Control device 214 may then communicate with building management system 500 to initialize the heat chamber.

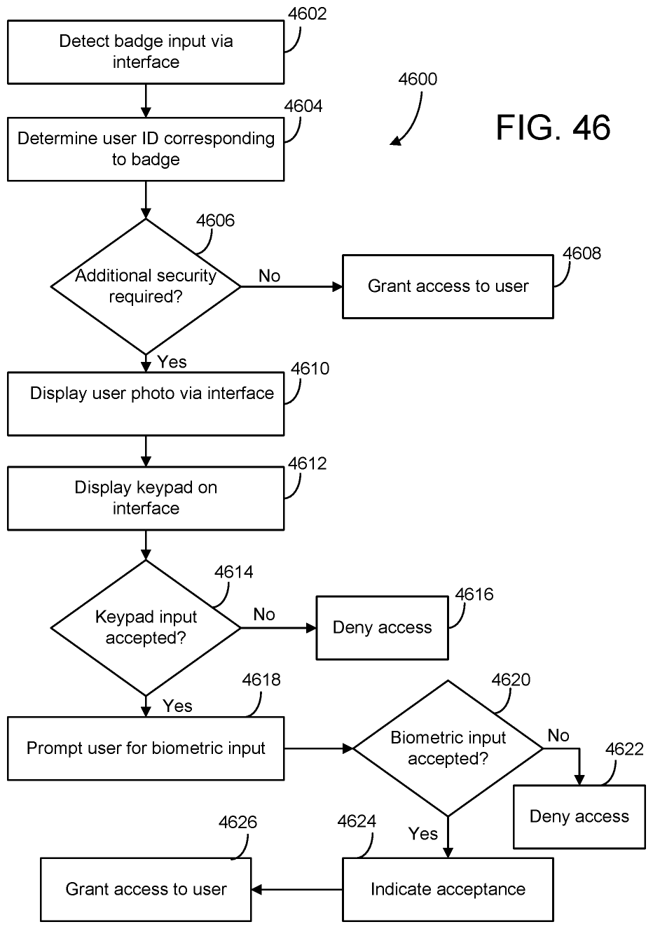

Referring now to FIG. 46, an example embodiment is provided to illustrate an access control method with multiple security layers. Method 4600 is shown to include detecting a badge input via an interface (step 4602) (e.g., via control device 214). Method 4600 is shown to further include determining a user ID corresponding to the badge (step 4604). Once a user ID has been determined, method 4600 includes determining if additional security is required (step 4606). In some embodiments, identity of the user may be used to determine if additional security is needed. For example, if the user ID corresponds to a maintenance worker, then additional security may not be required. Conversely, if the user ID corresponds to an individual with administrative rights, additional security may be required.

If additional security is not required (i.e., the result of step 4606 is “no”), then access may be granted to the user (step 4608). If additional security is required (i.e., the result of step 4606 is “yes”), then the user's photo may be displayed on the interface (step 4610) (e.g., electronic display 606). Method 4600 is shown to further include displaying a keypad on the interface (step 4612) (e.g., electronic display 606). The keypad may be presented as a touch screen (e.g., touch-sensitive panel 604). The user may then input a unique PIN. Method 4600 further includes determining if the keypad input is accepted (step 4614). If the keypad input is not accepted (i.e., the result of step 4614 is “no”), then access may be denied (step 4616).

Still referring to FIG. 46, if the keypad input is accepted (i.e., the result of step 4614 is “yes”), then the user may be prompted for a biometric input (step 4618). In some embodiments, the biometric input may include a fingerprint scanning and/or a retinal scanning. In some embodiments, facial recognition software may be used at step 4618. Method 4600 further includes determining if the biometric input is accepted (step 4620). In response to a determination that the biometric input is not accepted (i.e., the result of step 4620 is “no”), access may be denied (step 4622).

In response to a determination that the biometric input is accepted (i.e., the result of step 4620 is “yes”), then acceptance may be indicated to the user (step 4624). The indication of acceptance may be the same or similar to the indications previously described with respect to FIG. 42. Method 4600 further includes granting access to the user (step 4626). Step 4626 may be the same or similar to step 4212 as described with respect to FIG. 12. Additional or alternative security features may be included within control device 214 and/or method 4600.

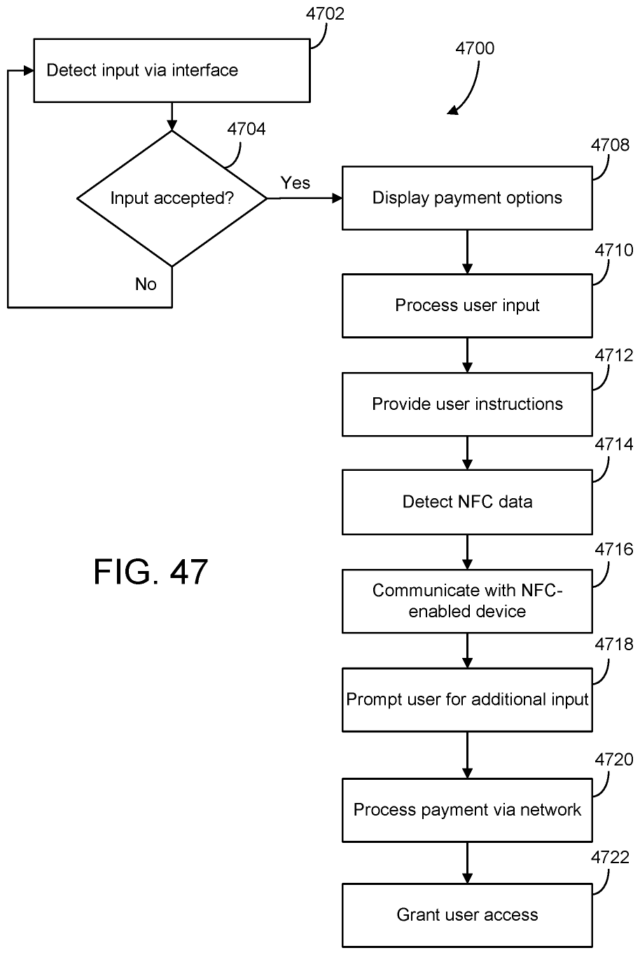

Referring now to FIG. 47, a method 4700 for access control with payment is shown. In some embodiments, method 4700 may be used to control access based on payment status (e.g., within a parking garage). Method 4700 is shown to include detecting an input via an interface (step 4702). Next, method 4700 is shown to include determining if the input is accepted (step 4704). If the input is not accepted (i.e., the result of step 4704 is “no”), then the user may continue to provide inputs. If the input is accepted (i.e., the result of step 4704 is “yes”), then control device 214 may display payment options (step 4708). The payment options may be displayed on control device 214, or may be communicated to a detected user device.

Method 4700 is shown to further include processing a user input (step 4710). The user input may include, for example, a selection of a payment option. Method 4700 may further include providing user instructions (step 4712). The user instructions may correspond to how to pay (e.g., “place smartphone near control device”). Next, method 4700 is shown to include detecting Near-Field Communication (NFC) data (step 4716). The data may originate from, for example, a user's smartphone. Next, control device 214 may communicate with the NFC-enabled device (step 4716). The communication between the NFC-enabled device and control device 214 may correspond to payment information.

Method 4700 is shown to further include prompting the user for additional information (step 4718). In some embodiments, the additional information may include a confirmation of a payment and/or payment amount. Next, method 4700 may include processing a payment via a network (step 4720) (e.g., network 546). In some embodiments, step 4720 may include communicating with the user's bank or financial institution to process the payment. Method 4700 further includes granting the user access (step 4722). As one non-limiting example, a user may make a payment via control device 214, and the parking garage may grant access to the user upon processing of the payment.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A control device for a building management system (BMS), comprising:
a touch screen display configured to mount to a mounting surface;
a communications interface configured to communicate with the BMS;
a near field communication (NFC) sensor configured to receive information from a NFC device;
a microphone configured to detect vocal input; and
a processing circuit coupled to the touch screen display and comprising a processor and memory coupled to the processor, the memory storing instructions thereon that, when executed by the processor, cause the control device to:
receive user input from at least one of the touch screen display, the NFC sensor, or the microphone;
validate an identity of a user based on the user input; and
cause the BMS to control an environmental variable of a space based on the validation.

2. The control device of claim 1, wherein the NFC device is a mobile device or a user identification badge.

3. The control device of claim 1, wherein controlling an environmental variable comprises controlling at least one of a door lock, a window lock, a gate arm, turnstile rotation, or a garage door.

4. The control device of claim 1, further comprising a retina sensor and wherein the instructions cause the control device to validate the user based on user input received from the retina sensor.

5. The control device of claim 1, wherein the touch screen display is a transparent touch screen display.

6. The control device of claim 1, wherein the user input from the touch screen display is a personal identification number (PIN).

7. The control device of claim 1, wherein causing the BMS to control an environmental variable comprises controlling at least one of an HVAC system, a lighting system, or a security system.

8. A building security system, comprising:
one or more security devices configured to secure a space;
a management system coupled to the one or more security devices and configured to control the one or more security devices;
a user control device configured to be mounted to a surface and comprising:
a touch screen display configured to provide a user interface to a user and receive tactile input from the user;
a near field communication (NFC) sensor configured to receive information from a NFC device;
a microphone configured to detect vocal input; and
a processing circuit configured to verify the user and, in response to verifying the user, cause the management system to control the one or more security elements.

9. The building security system of claim 8, wherein the NFC device is a mobile device or a user identification badge.

10. The building security system of claim 8, the one or more security devices comprising at least one of a door lock, a window lock, a gate arm, a turnstile, or a garage door.

11. The building security system of claim 8, the user control device further comprising a retina sensor and wherein the user control device verifies the user based on input received from the retina sensor.

12. The building security system of claim 8, wherein the touch screen display is a transparent touch screen display.

13. The building security system of claim 8, wherein the tactile input from the user is a selection of a personal identification number (PIN).

14. The building security system of claim 8, wherein the management system is coupled to at least one of an HVAC system, a lighting system, or a security system, and wherein the user control device is further configured to cause the management system control at least one of the HVAC system, the lighting system, or the security system.

15. A method of authenticating a user for a security system, comprising:
receiving, from a touch screen display, user touch input indicating a numerical sequence;
receiving, from a near field communication (NFC) sensor, a user device input indicating a user identifier;
receiving, from a microphone, user voice input identifying the user;
validating an identity of the user based on the user touch input, the user device input, and the user voice input; and
controlling one or more access devices to grant the user access to a secured space in response to validating the user.

16. The method of claim 15, wherein the NFC device is a mobile device or a user identification badge.

17. The method of claim 15, wherein controlling one or more access devices to grant the user access to a secured space comprises at least one of unlocking a lock, raising a gate arm, unlocking a turnstile, or opening a garage door.

18. The method of claim 15, the method further comprising receiving, from a biometric sensor, a user biometric input, wherein the user biometric input is a retina scan.

19. The method of claim 18, wherein the biometric input is a fingerprint scan.

20. The method of claim 15, wherein the touch screen display is a transparent touch screen display.
